(19) United States
(12) Patent Application Publication
(10) Pub. No.: US 2025/0124534 A1
(43) Pub. Date: Apr. 17, 2025

(54) MACHINE LEARNING TECHNIQUE FOR ENHANCING OBJECT DETECTION

(71) Applicant: Bastian Solutions, LLC, Indianapolis, IN (US)

(72) Inventors: Mark R. Cass, Boise, ID (US); Eric Michael Smith, Dallas, TX (US); Amey Sunil Kulkarni, Boise, ID (US); Shelby Lynne Cass, Corvallis, OR (US); Ruthvik Vaila, Boise, ID (US); Paola Andrea Gutierrez Guzman, Boise, ID (US)

(73) Assignee: Bastian Solutions, LLC, Indianapolis, IN (US)

(21) Appl. No.: 18/485,702

(22) Filed: Oct. 12, 2023

(51) Int. Cl. G06T 1/00; G06T 7/80

(52) U.S. Cl. CPC G06T 1/0014; G06T 7/80; G06T 2207/20081

(57) ABSTRACT

A system includes a camera system configured to capture images of items in a tote. The camera system is configured to interface with an artificial intelligence (AI) system to process images in a variety of ways to support picking and/or placing operations by a robot. Such processing includes planning pick points for items, applying a filter to an image, and planning movement of a robot to perform a picking operation. The camera system further includes an augmented reality tag (ARTag) that is used to calibrate cameras and other devices. The system is configured to train the AI system based on images collected by the camera system wherein the camera system randomly varies the camera settings for each image.

### BACKGROUND

Computer vision systems are used in a wide variety of environments, such as in autonomous vehicles and robotic systems, to recognize objects and environmental conditions. For instance, robots are utilized in material handling facilities, like warehouses and manufacturing plants, to automate various material handling tasks. The lighting, camera equipment, nature of the objects being handled, and other conditions may negatively impact the ability of the system to recognize objects.

Thus, there is a need for improvement in this field.

### SUMMARY

A unique machine learning technique and system has been developed for enhancing object detection. There has been a trend in computer vision systems using machine learning techniques to have a single image example of each object in training data so as to reduce training data sizes, but provide different views of similar objects such as from different camera positions or object orientations. A common use case for computer vision systems is for robots handling objects or other items in manufacturing and warehousing environments. Other use cases include autonomous vehicle navigation. While such systems can work quite well in tightly controlled laboratory conditions, the computer vision systems tend to operate less than optimal when used in real world manufacturing environments, warehousing environments, common driving conditions, and/or in other everyday environments. It was found that computer vision systems will randomly have issues (i.e., freak out or glitch) without any warning even when the viewing conditions appeared to be the same. For example, the system may not recognize objects being present or even hallucinate phantom objects that were not present, even though nothing appeared to be different in the viewing conditions.

One common approach to address this issue is to provide additional images at different viewing angles or object orientations so as to enhance the robustness of the computer vision model of the object. It was found that this training approach did not significantly address this random glitching in computer vision systems, however. Unexpectedly, it was discovered that generally taking a different approach addressed this issue. In one form, multiple images, such as ten (10) images, of the same static object, which appear to be exactly the same or identical to a human, are incorporated into the training data of the machine learning system. The images are from the same camera viewing position and the object does not move as the camera takes sequential pictures or images of the object. In other words, nothing in the foreground or background physically changes as the images are gathered by the camera. In some examples, two (2) to fifteen (15) of these static object images are used for training, and in other examples, four (4) to ten (10) of these static images are used in training. In another example, at least 10 to 100 images form the training set. In one particular form, the camera takes ten (10) sequential images in quick succession (e.g., as fast as the shutter speed or refresh rate allows) of the same object under the same environmental conditions. These multiple images form a static image training set. It should be recognized that these images can also be captured via separate frames in a video recording.

To be clear, the images forming the static image training set are not the same image that has been copied multiple times (e.g., 10 times) to fill out the set. Rather, the images are different images taken of the same object and scene with the same camera at the same viewing angle but at different times. When the images are captured, the object in the image and the surrounding scene remain unchanged and remain stationary. So as to capture subtle camera distortions, the same camera is used to take all of the images in a particular static training set. The camera is fixed in place and not moved while the images are captured. In one example, the camera captures the images in a burst of ten successive images in quick succession (i.e., as fast as the frame rate of the camera). For instance, each image may be captured every 1/60 of a second when the camera has a frame rate of 60 frames per second. In another example, the images are captured with a long delay in between successive frames (e.g., 1 hour) in a fashion similar to time lapse photography. The camera may capture the images at regular intervals or irregular intervals. In one form, the images are captured at irregular intervals to capture subtle changes in the images created by periodic changes in the scene, such as strobing effects caused by the frequency of the power grid, camera components, and/or vibrations created by equipment.

Before or during training, the image properties of one or more images in the static image training set are randomly changed (or some are not) and are used to train the vision system. These image properties can include, but are not limited to, contrast, chrominance, brightness, sharpness, color, saturation, white balance, and gamma values, to name just a few. In one version, all or some of these image property changes occur in post-production, that is, after the pictures are taken. For example, photo editing software can be used, either manually by a human or automatically via a computer, to change the image properties of one or more pictures in the image set. In another version, all or some of these image property changes occur as the photograph or image of the object are actually taken. For example, the brightness of the lights lighting the object is randomly changed as the series of pictures are taken by the camera. A combination of these approaches can be also used in which some image changes occur as the images are captured and others are changed in post-production. Combination approach for changing images can be used. For example, none of the images are changed when captured, and some or all of the captured images are changed during post-production. As another example, the parameters for some or all of the images are changed when the images are captured, and the captured images are further modified during post-production

Within the static image training set, some or most of the images may remain unchanged. In one version, only 10-20% of the images are randomly changed. For example, when ten images form the training set, only one or two of the images are randomly changed. In another version, 30-70% of the images are changed. In a further version, about half (40-60%) of the images are randomly changed, and in another version, 80-90% of the images are randomly changed in the training image set. In still yet other versions, all of the images in the training set (i.e., 100%) are changed in some form.

While not being bound to a specific theory and being uncertain as to actual cause, it is theorized that images of the same static object, which appear to be exactly the same or identical to a human, are in fact different from the perspective of the machine learning systems. For instance, imperceptible thermal gradients in a workspace may slightly change the index of refraction of air such that mirages and/or heat haze is created that is imperceptible to humans. As another example, the lighting environment, such as in the case of fluorescent lights or fluctuations in the power supply frequency, may cause the light brightness levels to ever so slightly fluctuate (e.g., strobe). The camera capturing may also cause these slight changes in image properties. For example, noise within the image sensor of the camera may create stray pixels or noise. Relying on just a single image of the object being positioned and viewed at a certain angle, an artificial intelligence (AI) system training with the image recognizes at least one of these human imperceptible image properties and incorporates them into the computer vision model for recognizing objects. In other words, the AI system latches onto a spurious image signal as being indicative or not of some object. During use, the presence of one or more of these human imperceptible image qualities may trigger the computer vision system to not recognize a physically present object or conversely imagine a phantom, nonexistent object. By being exposed to a series of extremely similar images in the static image training set with one or more having the image properties changed, the neural network system learns that small permutations do not affect the final object detected.

This machine learning training technique and system can be used in a wide variety of scenarios where computer vision object detection is used. This training technique can be universally applicable in that the camera used to generate the training data may not be the same one that utilizes the learned object detection models. In other words, the object detection ability created by the static image training data can be used in multiple object detection environments and with different camera as well as other different equipment than was used to create the static training images in the first place. For example, this technique and system can be used to train autonomous vehicles. As another example, this training technique is used to train robots for material handling activities.

In one non-limiting example, the technique is used to train robots performing picking and/or placing of items in warehousing and/or manufacturing environments. In one scenario, a camera is mounted on or positioned proximal to a robot in a fixed position. The camera in this scenario is the same one the robot uses to detect objects, but in other scenarios, one or more different cameras can be used. The camera is fixed in place so that the camera has a static viewing position or angle of the scene where one or more objects are handled by the robot. In one version, the camera captures images of one or more items in a tote. While the images are being taken, the items and tote remain stationary along with any other objects viewed by the camera such as the robot or a conveyor. Although images are captured separately, these images will appear to be the same to a human observer. In one form, the camera captures multiple images of this scene. In one particle version, the camera captures 50 to 2,500 images of this scene, and in another version, the camera captures 100 to 2,500 images of this scene. In still yet another example, eight (8) to ten (10) images of the scene are collected. In one example, the images are taken at regular intervals (e.g., 1/24 second intervals), and the images are captured in other versions at irregular intervals or randomly. As an example, the second image can be taken 1 second after the first image, and the third image or picture is taken 5 seconds after the second image and so on. The camera in one particular example captures 10 images of the scene within less than one second. It should be recognized that other intervals can be used and a different number of images can be taken.

In another non-limiting example, the technique is used to train robots used for loading and/or unloading trailers such as an ULTRA BLUE® brand industrial robot which is sold by Bastian Solutions, LLC of Indianapolis, Indiana. The camera in one scenario is mounted on or positioned proximal to the robot in a fixed position. The camera in this scenario is the same one the robot uses to detect objects. In another scenario, one or more different cameras can be used. For example, a camera separate from the robot is mounted on a tripod within a semi-trailer. The camera is fixed in place so that the camera has a static viewing position or angle of the scene where one or more objects are handled by the robot. For example, the camera may view a static scene of boxes loaded in the semi-trailer. In one version, the images are taken in rapid succession such that eight to ten images are captured within 1 second or ten images within 0.6 seconds.

Several semi-trailer types include translucent or semi-translucent roofs so as to provide lighting during the day. Consequently, the lighting within the semi-trailer may change throughout the day due to outdoor conditions and/or conditions within a loading dock as well as surrounding facilities. In another version, the camera captures the images using large intervals between consecutive images in a fashion similar to time lapse photography. In one form, the static image training set includes twelve images taken over a single day, and the interval between images is about two hours. For example, the camera can capture time lapse images within a trailer over a weekend. In another form, ten images are taken over a ten-hour period at random or irregular intervals. In still yet another form, the intervals between images is at least a half an hour and at most four hours. It should be recognized that other intervals and number of images can be used to form the static image training set. The image collection process can occur over a wide variety of time periods. For example, all of the images can be collected over a period of 1, 8, 12, 24, or 48 hours, to name just a few examples. As the images are taken by the camera, the boxes or other items within the trailer remain stationary. With this time lapse approach, the images forming the static image training set have their image properties naturally changed. For example, image brightness or color within the trailer may naturally change throughout the day. In one version, all of the images in the training set are not randomly or synthetically changed before being used for training the models. In other words, the original or natural images in the static image training set remain the same or unchanged when used for training. Instead of randomly changing one or more image properties in at least one of the images, the training technique relies on the environmental changes to create the random image property changes. In another variation, one or more of the images in the training set are manually changed by a human operator or automatically changed via a computer so as to have a further image property changed beside those that occurred naturally. For instance, image parameters in one image of a ten-image training set are randomly changed before being used for training. In some cases, the image properties can be extremely changed so as to make the objects in the changed training image almost unrecognizable. For example, the contrast may be reduced to an extent where a human would have difficulty in distinguishing objects in the image.

In most, but not all cases, the properties that are camera hardware related cannot be directly changed after the images are saved. For example, brightness and saturation of the image can be difficult to change after the image is saved. However, the changes in these parameters can be simulated using software. The images can be captured at regular or irregular intervals that are spread across different time durations. When the images are captured, natural changes may cause all of these captured images to be slightly different. Multiple images with different camera parameters can be captured right when the original image is captured. Software changes to these images can be generated in post-production to change certain parameters of the images. Once more, a combination of these three approaches can also be used to modify the images (or not).

With the pick-placing and loading-unloading robot examples discussed above as well as with other examples, the static image training set is transferred from the camera to the machine learning training system for incorporation into the much larger set of training data. In one form, the training data set includes the static image training set from the camera and/or other static image training sets from other cameras at different robots, and the training data set further includes images from other sources besides those that use the static image sampling technique. For instance, stock images and/or single images of the same or different objects can be incorporated. In one form, the static training images from the robots represent at most 10% of the images in the overall set of training data for training the machine learning system, and in further forms, the static training images represent at most 1% to 2% of the training data set. In another example, the static image training sets form about half (e.g., 40% to 60%) of the training data set. In still yet other selected examples, the static image training sets form most (e.g., 80%) or all (i.e., 100%) of the training data set.

Before or after being incorporated into the set of training data, the image properties of at least one of the images in the static image training set from the camera is changed in most cases. As noted before with respect to the time lapse example of the truck loading-unloading robot, there are some cases in which the technique relies on natural changes in the static image properties to passively change at least one of the images in the static image training set (i.e., without actively making the image property change). In most cases, however, the image properties of these selected images are actively changed, either manually by a human or automatically by a computer. For example, the machine learning system automatically changes one or more image properties of one or more images within the static image training set. In some cases, 1% to 2% of the images within the static image training set are changed automatically via the computer. For instance, when the static image training set includes 10 images, then the image properties of one or two of the images are randomly changed. In the computer of one version, a random number generator, such as via a seed value, generates one or more random numbers for determining which image to change and which image properties to change as well as to the extent of the changes.

In other variations, the image and/or image property are not randomly selected. Instead, the machine learning system selects the image with the greatest outlier image property and further exaggerates that image property. In other words, the system compares the images within the static image training set to find at least one image with one or more image properties that deviate the most from the rest of the images, and in turn, the system further distorts the outlier image based on the outlier properties. By further distorting these outlier images and/or image properties, while not certain, it is theorized that this approach may identify image properties that require desensitization on the part of the AI system. To provide an example, the system calculates the average brightness of the images along with the standard deviation (or sample standard deviation) of brightness of ten images within a static image training set. The one image with a brightness value that deviates the most from the average is then distorted by increasing or decreasing the image brightness by some percentage, a multiple of the standard deviation value (e.g., three times the standard deviation), and/or in other manners. For instance, if the overall brightness of the image is less than the average, the brightness of the image is reduced by say 50%.

While images that are changed with this technique will be generally described as only occurring for those images within the static image training set, it should be recognized that other images from the entire set of training data can be modified in a similar fashion. For instance, the system can randomly select images from the entire training data set and randomly change one or more image properties of the selected images.

Once the appropriate images are modified within the training data set, the machine learning or AI system can train to develop models for identifying objects and other parameters in a number of manners, such as via supervised learning, unsupervised learning, and/or reinforcement learning approaches. Once more, while not certain, it is thought that this approach helps to teach or desensitize the AI system so as to ignore spurious visual anomalies and focus on the objects of interest. Once the training is complete, the model can be transmitted to one or more robots for picking-placing, loading-unloading, and/or other activities performed by the robots. This technique is quite adaptable to a wide variety of computer vision activities. For instance, this technique is not limited to specific camera equipment and/or object recognition environments. Moreover, it has been found that this training technique considerably reduces issues with robot operations. For example, this technique can reduce false positives or negatives for object detection.

Moreover, a unique camera system has been developed to identify potential pick points in a material handling system. This camera system technique can be used by itself or in conjunction with the above-described static image training technique. The camera system includes a variety of uses and features. For example, the system includes one or more settings configured to modify the pick settings of the material handling system. In another example, the system includes a calibration procedure configured to enable automatic calibration of a new and/or replacement camera, regardless of camera type.

The camera system includes a programmable filter system configured to control available and/or unavailable picks. In one example, the filter is configured to prevent item picks where the item is over 30 cm (12 inches) tall. In another example, the filter is configured to prevent item picks outside of a predetermined range. In another example, the filter is used to black out and/or prevent picks within a certain area. As should be appreciated, other filters are applied based on the needs of a user.

In another embodiment, the camera system is configured to pre-plan pick points to avoid singularities. For example, the camera system may limit one or more degrees of freedom of a robot based on the proximity of other robots and/or equipment.

Camera calibration is facilitated via an augmented reality (AR) tag and/or ARTag mounted to a robot arm. In one example, the ARTag is mounted to the robot arm adjacent an end of the robot arm. In one embodiment, the camera compares the location of the ARTag and the end of the robot arm to facilitate camera calibration. For example, code is used to calculate a difference between the ARTag and the end of the robot arm. The difference between the position of the ARTag and the end of the robot arm is used as a calibration correction factor to calibrate the camera. As should be appreciated, other objects within the environment, such as totes, end of arm tools (EoATs) or end effectors, can be calibrated based on the calibrated camera.

The camera system is further configured to interface with an artificial intelligence (AI) system. In one embodiment, the AI system is configured to identify items, totes, and/or pick locations. In another embodiment, the camera system is configured to capture multiple images of items and/or totes that are used to train the AI system. For example, the AI system is trained to identify the position, shape, orientation, and/or other information about items in a tote. Like in the static image training technique described above, the camera system is configured to randomly vary a setting on a camera between capturing each image. In one example, the brightness, contrast, aperture, and/or other settings are randomly varied for each image the camera captures. In another variation, the change in the image properties occur after the images are captured.

The depth calibration of a red, green, blue plus depth (RGBD) camera is similarly trained to desired depth accuracy through the presence of a three-dimensional (3D) target. In one example, the RGBD camera has two (2) red, green, blue (RGB) sensors that are angled relative to one another, and in another example, the RGBD camera has a single RGB sensor and single depth camera. With the technique, a target is placed within the field of view of the fixed RGBD camera, and a user is prompted to specify the allowable depth variation in a sample and to select the area around the target in the RGB image. A calibrator then acquires the 3D target based on user input and checks the depth image to see if the target is within the specified depth tolerance. The RGBD camera is then commanded to vary camera parameters and processing of the depth image produced until the target meets the tolerances provided. This method allows for a high level of confidence when delineating objects of relatively small size.

The major stages of any deep learning pipeline include, but are not limited to, data collection, data annotation/labeling, model training on training dataset, testing the models on test dataset, and deploying the model such as at a customer site (also known as, “model inference”). During deployment, the cameras are normally calibrated for that site. There are various kinds of camera calibration techniques that can be used. For example, some camera calibration techniques include RGB parameter calibration, depth parameter calibration, camera-robot calibration, extrinsic and intrinsic camera calibration, to name just a few. The collection of static images at regular or irregular intervals of time, the collection of images with different camera parameters, and/or the changing the image properties during postproduction can help in the training phase of the deep learning pipeline as mentioned previously. However, these images can also help in other stages of the pipeline and during camera calibration phase. Some of the possible areas where these images can help are mentioned below.

Test time augmentation can be implemented during the testing phase and the model inference phase of the deep learning pipeline. The basic concept of test time augmentation is that not just one image is used when performing a prediction. Instead, an image is collected and augmented using different data augmentation techniques like image rotation, image translation, adding image jitter, and the like. After the data augmentation, predictions are performed on all of these augmented images, and finally, the predictions are combined to get a better, robust prediction.

With the present technique, multiple images are collected with the same or different camera parameters. Alternatively or additionally, the image properties may be changed in postproduction. Once the multiple images are collected and processed, the predictions are generated on all these images. All these images are collected with the same camera position and the same scene. Since all these images are slightly different, the predictions of these images will also be different. With this technique, these predictions are finally averaged out or other statistical tools are used to combine the predictions. When performing model inference, multiple images are collected with static or dynamic camera parameters, and certain postproduction filtering is performed. When testing the model on a test dataset, the candidate test image can be taken, and multiple variations of the test image are generated using just the post production filters.

Deep learning models usually need a lot of data to train and test the models. This data needs to be labeled very accurately to perform supervised learning. Annotations are ground truth values for the task that need to be performed. For example, when doing instance segmentation, if an image has 5 objects, the annotations/labels will have pixel wise masks for each object. This tells the model that all mask pixels of the same color belong to the same object. These annotations are very time consuming and expensive to generate. With the present unique technique, the demand for labelling is reduced, because the same image with just different image properties is used for training. Since the image is the same, the same labels in the image are applicable even though the image properties are different. With this technique, multiple versions of the same image with different image properties can be created in a number of manners. For example, multiple images can be collected with static camera parameters to create multiple versions of the same image. In another example, multiple images of the same scene with different camera parameters are collected to have multiple versions of the same image with different image properties. In still yet another example, the saved image is augmented using postprocessing algorithms to have multiple versions of the same image with different image properties. The predictions can be performed on all versions of the image and all these predictions can later be combined using standard processes into one final prediction. This generates the initial robust baseline annotations for the image. While these annotations may not be the most accurate, the work performed by humans to correct these annotations or add/delete the annotations is significantly less than if these baseline annotations from the model were not available.

In another variation, the camera parameters are changed while collecting images for color calibrating the cameras. In one form, multiple blocks of assorted colors are placed in front of the camera. The color blocks can be for example red, green, blue, white, black, yellow, and/or other colors. Typically, but not always, the blocks in front of the camera have bright and/or light colors. In one form, the arrangement of the objects are preferably medium to hard challenging. There are several ways to make the arrangement challenging. For example, some of the items are partially occluded. In another example, items with similar colors are placed adjacent to each other, and in further examples, some items are stood up vertically while other items lay horizontally or in other orientations. The color calibration is performed to select the camera parameters that help the model detect all of these objects with high accuracy. The procedure to color calibrate the cameras is performed in the following manner.

1. The color blocks are placed in front of the camera in a slightly hard arrangement. Instead of using color blocks, it is also possible to keep the general stock keeping unit (SKU) items in front of the camera so as to determine the camera parameters for the particular site.

2. At least one image is collected of these blocks. This image is annotated by a human so as to have the ground truth for this image/arrangement.

3. When a new image is collected, the predictions are generated based on the image, and the quality of the prediction is determined by comparing the prediction with the annotated ground truth.

4. Different camera parameters are cycled through randomly within a range for each camera parameter. Multiple images are captured at each set of camera parameters. In one version, 5 to 10 static images are captured for each set of camera parameters. Predictions are determined on each image, and an average metric is calculated for each set of camera parameters. The set of camera parameters with the highest average score is finalized for the camera site. Almost all cameras have multiple parameters to tune. For the sake of simplicity, only three parameters are considered for this example. In this example, the camera has only three parameters that can be tuned, brightness, contrast, and exposure. The images are captured at different values of these camera parameters. For instance, a first set (set 1) of 10 images is collected with B=2, C=3, E=5. The predictions are compared on all the images with the ground truth, and the average metric value is calculated for the first set (set 1). Intersection Over Union (IoU) is one of the common metrics used. A second set (set 2) of 10 images is for example collected with B=4, C=1, E=10. The predictions are compared on all the images with the ground truth, and the average IoU score value is calculated for the second set (set 2). Multiple such sets can be collected. In one variation, the system cycles through the process by randomizing these parameters for 1-2 hours. In another variation, depending on how much time is available, the system runs through the randomizing process for 2-5 minutes. The system in one form calculates the average score value for ten of such sets. At the conclusion, the set with the highest average metric is determined, and the final camera parameters for that set are used for the camera site. Instead of calculating the mask IoU, the system in another version just calculates the number of items predicted and the number of items in a bin to speed up the process.

In another variation, this process is repeated for multiple different arrangements of the color blocks or the SKU items. In this version, at least the top 5 sets of camera parameters for each arrangement are found and then the set of camera parameters that appear in all the sets are determined. This further helps to find a robust set of camera parameters. This calibration process helps in finding a good set of camera parameters. However, this same process can also be used to set other image properties, image processing filter parameters, and the like.

Moreover, this technique does not need be confined to just RGB images/cameras. For instance, this technique can be applied to images from depth cameras, infrared cameras, and the like. Moreover, various kinds of sensors can be used to collect sensor data. Due to environmental conditions, captured sensor data may vary even if the sensor parameters are not changed. Similar to the technique used with the RGB cameras, the sensor parameters can be tuned to collect multiple data samples of the same scene. Postprocessing can be applied to the sensor data to add perturbations to sensor data.

The system and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a network.

Aspect 3 generally concerns the system of any previous aspect including a robot.

Aspect 4 generally concerns the system of any previous aspect in which the robot is configured to handle one or more objects.

Aspect 5 generally concerns the system of any previous aspect including a camera.

Aspect 6 generally concerns the system of any previous aspect in which the camera is configured to capture two or more images of one or more objects.

Aspect 7 generally concerns the system of any previous aspect in which the camera configured to capture two or more images of one or more objects that are stationary.

Aspect 8 generally concerns the system of any previous aspect including an artificial intelligence (AI) system.

Aspect 9 generally concerns the system of any previous aspect including the artificial intelligence (AI) system operatively coupled to the network.

Aspect 10 generally concerns the system of any previous aspect in which the camera is configured to interface with the artificial intelligence (AI) system.

Aspect 11 generally concerns the system of any previous aspect in which the objects are stationary when the camera captures the images.

Aspect 12 generally concerns the system of any previous aspect in which the camera is mounted at a fixed position when the images are captured.

Aspect 13 generally concerns the system of any previous aspect in which the camera is mounted proximal to the robot.

Aspect 14 generally concerns the system of any previous aspect in which the camera is mounted in a trailer when the images are captured.

Aspect 15 generally concerns the system of any previous aspect in which the camera is mounted to view a tote holding the objects when the images are captured.

Aspect 16 generally concerns the system of any previous aspect including the artificial intelligence (AI) system operatively coupled to the camera.

Aspect 17 generally concerns the system of any previous aspect in which the camera is operatively coupled to the network.

Aspect 18 generally concerns the system of any previous aspect in which the images of the objects form an image training set that is used by the artificial intelligence (AI) system to develop a machine learning model for the objects.

Aspect 19 generally concerns the system of any previous aspect in which the image training set includes at least 50 images.

Aspect 20 generally concerns the system of any previous aspect in which the image training set includes at least 100 images.

Aspect 21 generally concerns the system of any previous aspect in which the image training set includes at most 1,000 images.

Aspect 22 generally concerns the system of any previous aspect in which the image training set includes at most 2,500 images.

Aspect 23 generally concerns the system of any previous aspect in which the image training set has 100 to 2,500 images.

Aspect 24 generally concerns the system of any previous aspect in which the camera is configured to capture the images at regular intervals.

Aspect 25 generally concerns the system of any previous aspect in which the intervals are 1/60 second intervals.

Aspect 26 generally concerns the system of any previous aspect in which the camera is configured to capture the images in a rapid burst.

Aspect 27 generally concerns the system of any previous aspect in which the images are successive images in time captured by the camera.

Aspect 28 generally concerns the system of any previous aspect in which the camera is configured to collect the images using a time lapse approach.

Aspect 29 generally concerns the system of any previous aspect in which the camera is configured to captures the images with a long interval between successive images.

Aspect 30 generally concerns the system of any previous aspect in which the interval is at least half an hour.

Aspect 31 generally concerns the system of any previous aspect in which the interval is at least one hour.

Aspect 32 generally concerns the system of any previous aspect in which the camera is configured to capture the images at irregular intervals.

Aspect 33 generally concerns the system of any previous aspect in which the image training set has one or more modified images with at least one image property different from the other images.

Aspect 34 generally concerns the system of any previous aspect in which the images when captured by the camera appear to be the same when viewed by a human.

Aspect 35 generally concerns the system of any previous aspect in which the image property includes brightness.

Aspect 36 generally concerns the system of any previous aspect in which the image property includes chrominance.

Aspect 37 generally concerns the system of any previous aspect in which the image property includes contrast.

Aspect 38 generally concerns the system of any previous aspect in which the image property includes hue.

Aspect 39 generally concerns the system of any previous aspect in which the image property includes color.

Aspect 40 generally concerns the system of any previous aspect in which the image property includes gamma value.

Aspect 41 generally concerns the system of any previous aspect in which the modified images form 30% to 70% of the images in the training set.

Aspect 42 generally concerns the system of any previous aspect in which the modified images form 100% of the images in the training set.

Aspect 43 generally concerns the system of any previous aspect in which the camera is configured to create the modified images by changing the image property.

Aspect 44 generally concerns the system of any previous aspect in which the image property includes aperture size of the camera.

Aspect 45 generally concerns the system of any previous aspect in which the camera is configured to create the modified images by taking the images through a time lapse approach.

Aspect 46 generally concerns the system of any previous aspect in which the modified images are created as the images are taken by the camera.

Aspect 47 generally concerns the system of any previous aspect in which the modified images are created after the images are taken by the camera.

Aspect 48 generally concerns the system of any previous aspect in which the artificial Intelligence (AI) system is configured to create the modified images by changing the image property.

Aspect 49 generally concerns the system of any previous aspect in which the modified images are created before the artificial intelligence (AI) system develops the machine learning model.

Aspect 50 generally concerns the system of any previous aspect in which the image training set only forms part of a training set used by the artificial intelligence (AI) system to develop the machine learning model.

Aspect 51 generally concerns the system of any previous aspect in which the image training set represents at most 10% of the training set.

Aspect 52 generally concerns the system of any previous aspect in which the image training set represents at most of about half of the training set.

Aspect 53 generally concerns the system of any previous aspect in which the robot configured to receive the machine learning model from the artificial intelligence (AI) system.

Aspect 54 generally concerns the system of any previous aspect in which the robot configured to handle one or more items based on the machine learning model developed by the artificial intelligence (AI) system.

Aspect 55 generally concerns the system of any previous aspect in which the camera is configured for use with an automated material handling system.

Aspect 56 generally concerns the system of any previous aspect including an augmented reality tag (ARTag) configured to facilitate automatic calibration of the camera.

Aspect 57 generally concerns the system of any previous aspect in which the camera is configured to calculate a camera calibration correction factor.

Aspect 58 generally concerns the system of any previous aspect in which the camera is configured to calibrate one or more totes, end of arm tools (EoATs), and/or drop locations based on the calibration correction factor.

Aspect 59 generally concerns the system of any previous aspect including a robot arm.

Aspect 60 generally concerns the system of any previous aspect in which the ARTag is mounted adjacent an end of the robot arm.

Aspect 61 generally concerns the system of any previous aspect in which the calibration correction factor is calibrated based on a distance differential between the ARTag and the end of the robot arm.

Aspect 62 generally concerns the system of any previous aspect in which the camera is configured to pre-plan item pick points.

Aspect 63 generally concerns the system of any previous aspect in which the camera includes one or more programmable filter settings configured to modify a picking process.

Aspect 64 generally concerns the system of any previous aspect in which the filter settings include an item size limit.

Aspect 65 generally concerns the system of any previous aspect in which the filter settings include an item position limit.

Aspect 66 generally concerns the system of any previous aspect in which the camera is configured to interface with the AI system to limit movement of the robot to prevent singularities.

Aspect 67 generally concerns the system of any previous aspect in which the robot includes a robot arm and an end effector coupled to the robot arm.

Aspect 68 generally concerns the system of any previous aspect in which the robot is a robotic shuttle.

Aspect 69 generally concerns the system of any previous aspect in which the robot is a gantry style robotic vehicle.

Aspect 70 generally concerns the system of any previous aspect in which the robot is a robotic mast vehicle.

Aspect 71 generally concerns the system of any previous aspect in which the robot is an autonomous vehicle.

Aspect 72 generally concerns the system of any previous aspect in which the robot is configured to load and/or unload the items from a trailer.

Aspect 73 generally concerns the system of any previous aspect in which the camera is incorporated into the robot that handles the objects.

Aspect 74 generally concerns a method.

Aspect 75 generally concerns the method of any previous aspect including capturing with a camera two or more images of one or more objects.

Aspect 76 generally concerns the method of any previous aspect including creating an image training set from the images of the objects.

Aspect 77 generally concerns the method of any previous aspect including modifying at least one of the images in the image training set to create a modified image that has at least one image property different from the remaining images in the image training set.

Aspect 78 generally concerns the method of any previous aspect including developing with a machine learning system a machine learning model for the objects based at least on the image training set that contains modified image.

Aspect 79 generally concerns the method of any previous aspect including performing an action with a robot based on the machine learning model.

Aspect 80 generally concerns the method of any previous aspect in which the camera creates the modified image.

Aspect 81 generally concerns the method of any previous aspect in which the machine learning system creates the modified image.

Aspect 82 generally concerns the method of any previous aspect in which the capturing includes capturing the images at a regular interval.

Aspect 83 generally concerns the method of any previous aspect in which the capturing includes capturing the images at irregular intervals.

Aspect 84 generally concerns the method of any previous aspect in which the capturing includes capturing the images using a time lapse approach.

Aspect 85 generally concerns the method of any previous aspect in which the images in the image training set appear to be the same image to a human before the modifying.

Aspect 86 generally concerns the method of any previous aspect in which the performing the action with the robot includes handling one or more items with the robot.

Aspect 87 generally concerns the method of any previous aspect in which the performing the action with the robot includes navigating an autonomous vehicle.

Aspect 88 generally concerns the method of any previous aspect in which the detecting an augmented reality tag (ARTag) at an end of a robot arm with a camera.

Aspect 89 generally concerns the method of any previous aspect including calibrating the camera based on a position of the ARTag.

Aspect 90 generally concerns the method of any previous aspect including calibrating the camera based on a distance differential between the ARTag and the end of the robot arm.

Aspect 91 generally concerns the method of any previous aspect in which the modifying the images occurs during the capturing.

Aspect 92 generally concerns the method of any previous aspect in which the modifying the images occurs after the capturing.

Aspect 93 generally concerns the method of any previous aspect in which the modifying the images occurs during post-production.

Aspect 94 generally concerns the method of any previous aspect in which the modifying the images occurs during and after the capturing.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram of a material handling system.

FIG. 2 is a block diagram of a camera system, a part of the FIG. 1 material handling system.

FIG. 3 is a diagram of a picking facility, a part of the FIG. 1 material handling system.

FIG. 4 is a diagram of a trailer loading facility, a part of the FIG. 1 material handling system.

FIG. 5 is a block diagram of a computer that can be incorporated in the FIG. 1 material handling system.

FIG. 6 is a perspective view of a tote and items in the FIG. 3 picking facility, captured in an image with one selection of image properties.

FIG. 7 is a perspective view of the FIG. 6 tote and items captured in an image with another selection of image properties.

FIG. 8 is a perspective view of the FIG. 6 tote and items captured in an image with yet another selection of image properties.

FIG. 9 is a perspective view of a trailer and items in the FIG. 4 trailer loading facility, captured in an image with one selection of image properties.

FIG. 10 is a perspective view of the FIG. 9 trailer and items captured in an image with another selection of image properties.

FIG. 11 is a perspective view of the FIG. 9 trailer and items captured in an image with yet another selection of image properties.

FIG. 12 is a flowchart of a technique for training an artificial intelligence system.

FIG. 13 is a flowchart of another technique for training an artificial intelligence system.

FIG. 14 is a flowchart of a technique for operating the FIG. 2 camera system.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

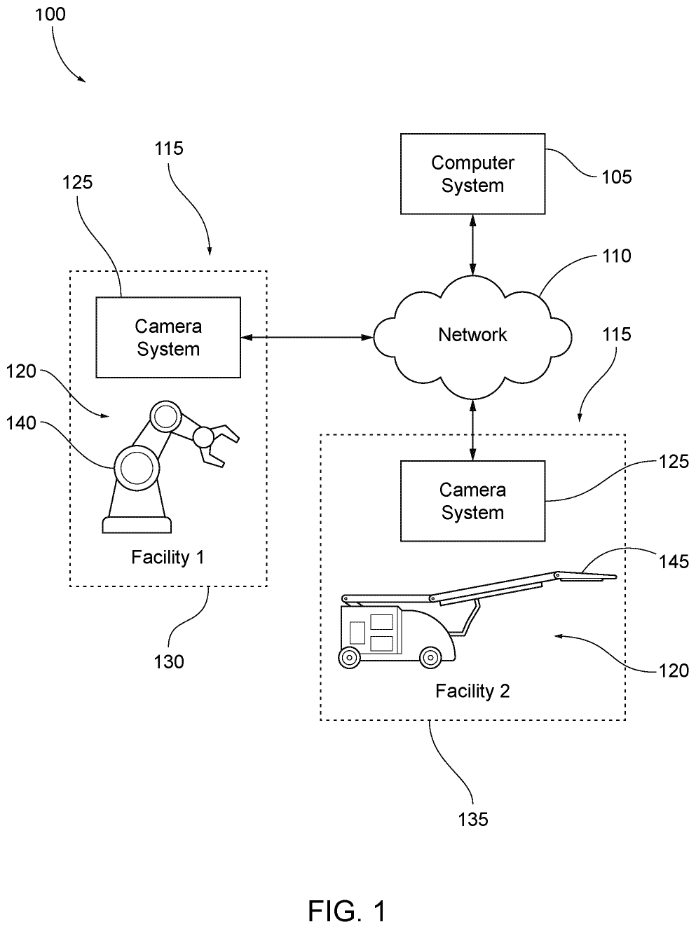

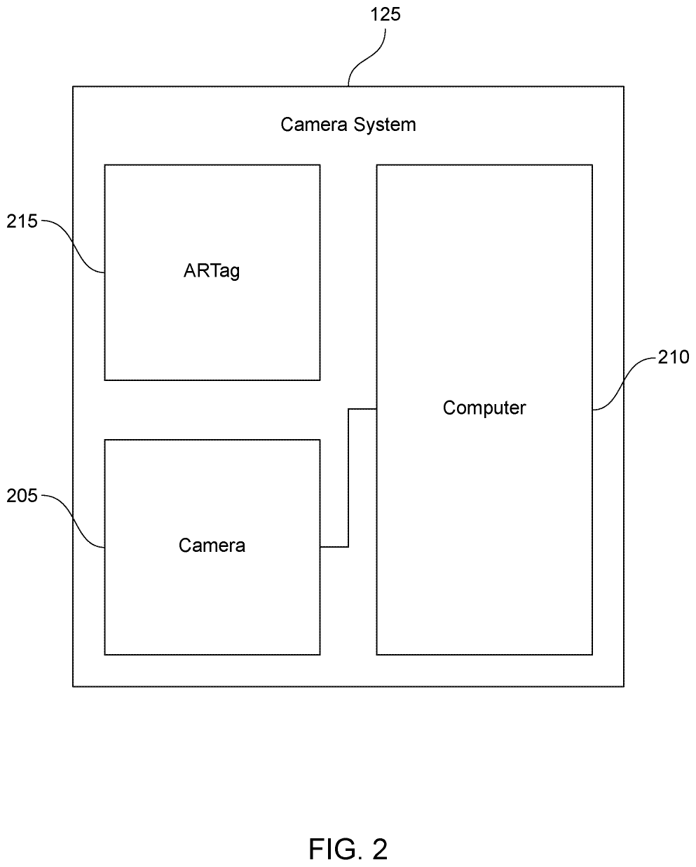

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

Referring to FIG. 1, a material handling system 100 is configured to perform various tasks. For example, the material handling system 100 may be utilized for storage, inventory management, manufacturing, fulfilling orders, and/or other purposes. In one embodiment, the material handling system 100 is fully automated to perform such tasks. The material handling system 100 generally includes a computer system 105, a wide area network 110, and one or more facilities 115.

The computer system 105 is configured to control various operations of the material handling system 100. For example, the computer system 105 may receive data over the wide area network 110, determine an action based on the data, and send commands to other parts of the material handling system 100 using the wide area network 110. Further, the computer system 105 is generally configured to process data, perform algorithms, store data, and/or perform other tasks. The computer system 105 includes one or more computers to perform such tasks.

As illustrated, the wide area network 110 is configured to communicatively connect the components of the material handling system 100. The wide area network 110 utilizes wired, wireless, or a combination of wired and wireless connections to support communication throughout the material handling system 100. For example, the wide area network 110 may utilize the internet. Further, the wide area network 110 may include one or more computers in one example. In one embodiment, the wide area network 110 connects systems within multiple facilities 115 that are spaced apart geographically, such as in different cities or countries. As should be appreciated, the wide area network 110 can be used to connect systems in many geographical arrangements. In one example, the wide area network 110 may connect multiple systems in the same building, such as in a warehouse or a fulfillment center.

The main tasks of the material handling system 100 are performed within the facilities 115. Each facility 115 generally includes a robot 120 that is configured to perform a variety of material handling tasks. For example, the robot 120 may be configured to pick/place items in totes, load/unload items in a trailer, rearrange items, and/or perform other actions on a variety of objects. The facility 115 further includes a camera system 125 that is configured to monitor operations in the facility 115. The camera systems 125 are configured to perform computer vision tasks, such as identifying, determining the shape of, and/or tracking the position of objects to name a few examples. The robot 120 is configured to receive instructions from the camera system 125 and/or computer system 105 to perform various operations. In some embodiments, the facilities 115 include additional equipment, devices, and/or structures that are used to perform material handling tasks. For example, the facilities 115 can further include conveyors, pallets, shelving, loading docks, vehicles, and/or other equipment.

In the illustrated embodiment, the facilities 115 include a picking facility 130 and a trailer loading facility 135. The picking facility 130 is generally utilized for picking and placing items, and the robotic arm 140 is generally utilized for trailer loading and unloading. As should be appreciated, the material handling system 100 can include any number of facilities 115 that are configured for any number of purposes. Additionally, the facilities 115 may be located within the same warehouse, manufacturing plant, or other building. For example, one portion of a building is designated as the picking facility 130 for placing items into boxes and another portion is designated as the robotic arm 140 for placing the boxes into a trailer. In one embodiment, multiple camera systems 125 within the same facility 115 are configured to monitor different operations within the facility 115. For example, the picking facility 130 may include one camera system 125 configured to monitor a picking operation and one camera system 125 configured to monitor a placing operation. As should be appreciated, each facility 115 can include any number of camera systems 125.

As illustrated, the robots 120 in the facilities 115 include a robotic arm 140 and a robotic mast vehicle 145. As should be appreciated, the facilities 115 can include more than one type of robot 120 and can include additional types of robots 120, such as a gantry robot, delta robot, robotic shuttle, and/or another type of robot 120. In the illustrated example, the robot 120 in the picking facility 130 is a robotic arm 140. The robotic arm 140 is configured to perform picking and/or placing operations, such as for moving items in a tote or on a pallet as examples. The robotic arm 140 is configured to move within a set area and to reach most or even all locations within the area. For example, the robotic arm 140 is an arm with six joints that support movement with six degrees of freedom. In the trailer loading facility 135, the robot 120 is a robotic mast vehicle 145. The robotic mast vehicle 145 is configured to load and/or unload boxes, packages, and/or other items onto a trailer. In some cases, the robotic mast vehicle 145 can load and/or unload items onto a shelving unit, storage structure, and/or other type of structure.

Referring to FIG. 2, the camera system 125 generally includes a camera 205. The camera 205 is configured to capture images of objects within the facility 115. In one embodiment, the camera system 125 includes multiple cameras 205. For example, multiple cameras 205 can be positioned to capture multiple views of the same object, views of multiple different objects, and/or combinations of such views. In this way, the camera system 125 is configured to monitor various parts of the facility 115.

The camera system 125 is configured to utilize multiple types of cameras 205. For example, the camera system 125 can operate in the same way when one camera 205 is replaced for another camera 205 with a differing brand, model, construction, and/or other characteristics. Further, the camera 205 is configurable to vary settings that affect the quality and characteristics of captured images. For example, settings on the camera 205 may modify the brightness, tint, contrast, aperture, focus, shutter speed, and/or another characteristic of an image. Generally, the changes in the type of camera 205 or the settings on the camera 205 affect the quality and characteristics of captured imaging. The camera system 125 is configured to operate consistently despite such changes. In one embodiment, the camera system 125 interfaces with an AI model that is trained to perform computer vision tasks with a consistent accuracy when settings on the camera 205 change or when the type of camera 205 changes.

As illustrated, the camera system 125 further includes a computer 210 that is connected to and configured to communicate with the camera 205. The computer 210 is configured to process image data from the camera 205 and perform other computing tasks based on the images. The camera 205 and computer 210 are connected using wired and/or wireless connections. In one example, the computer 210 may be integrated with the camera 205 in a common enclosure. In one embodiment, the camera system 125 includes multiple computers 210. For example, the multiple computers 210 may be connected to corresponding cameras 205 and/or may perform different computing tasks for one camera 205. As should be appreciated, another computer that is communicatively connected to the computer 210 may perform such tasks based on the images, such as the computer system 105 and/or another computer in the material handling system 100.

The computer 210 is further configured to calibrate the camera 205 and/or the entire camera system 125. In one embodiment, the computer 210 is configured to vary a setting of the camera 205. For example, the computer 210 may communicate to the camera 205 to change a physical parameter of the camera 205, such as the aperture or shutter speed as examples. In one embodiment, the computer 210 instructs the camera 205 to capture image data that is used to train an AI model embodied on the camera system 125 and/or another computer. For example, the computer 210 may instruct the camera 205 to capture a set of images wherein the camera settings are varied randomly for each image. The AI model may be trained using those images such that the AI model is capable of performing computer vision tasks for a variety of camera settings. In this way, the computer 210 is used to effectively calibrate the camera system 125 such that the camera system 125 operates consistently with any or nearly any type of camera 205 and settings on the camera 205.

In an additional or alternative example, the computer 210 is configured to utilize post-processing to alter image data in a similar way to varying settings of the camera 205. For instance, the computer 210 can digitally vary image properties of the captured images, such as brightness, contrast, vibrance, hue, saturation, color, exposure, gamma, offset, sharpness, blur, and/or other characteristics. In one example, the computer 210 automatically changes one or more image properties, such as randomly varying the image properties within a given range. In another example, a human operator may use the computer 210 to manually change one or more image properties. In this way, the set of images can be used to train the AI model such that the AI model can perform computer vision tasks in a variety of circumstances.

In another embodiment, the computer 210 is configured to capture a set of images through the camera 205 with varied environmental factors. The variation in environmental factors causes changes in the image properties of the images. In some cases, the changes are minute or even imperceptible to a human observer. In one instance, the computer 210 is configured to capture images quickly to capture differences in the environmental factors vary based on the operations of equipment in the facility 115. Such environmental factors include vibrations from operating equipment, mirages from heat released by equipment, fluctuations in lighting due to the frequency of the power grid, and/or other factors. In another instance, the computer 210 is configured to capture images over a longer time period to capture broader changes in the environment, such as capturing images as the lighting changes over the course of a 24-hour cycle. Again, the computer 210 is configured to use the images to train an AI model to perform a variety of computer vision tasks. By training the AI model in this way, the AI model can perform such tasks consistently despite variations in the environment conditions.

Typically, but not always, the computer 210 processes images of objects that the robot 120 can pick, place, and/or otherwise interact with. In one embodiment, the computer 210 is configured to apply filters to the images received from the camera 205. In one example, the computer 210 may filter out items based on a size limit. For example, the size limit may denote the size of an item that is too large for the robot to pick. Alternatively, the size limit may denote the size of an item that is too small for the robot to pick. In another example, the computer 210 may filter out items based on a position limit. For example, the position limit may denote a position that is outside the reach of the robot. Alternatively, the position limit may denote a position where a part of the robot could collide with a structure, another robot, and/or other equipment in the facility 115. In yet another example, the position limit may denote a position within a tote where the robot is unable to pick.

The camera system 125 further includes an augmented reality tag (ARTag) 215 that facilitates calibration. The ARTag 215 is mounted on other equipment and/or structures in the facility 115 that are in view of the camera 205. The computer 210 is configured to identify the ARTag 215 within an image captured by the camera 205. The camera system 125 is further configured to calibrate the position and/or orientation of the camera 205 based on capturing images of the ARTag 215. In one embodiment, the computer 210 stores information about the location of the ARTag 215 and utilizes that information to determine the locations of other objects in the image.

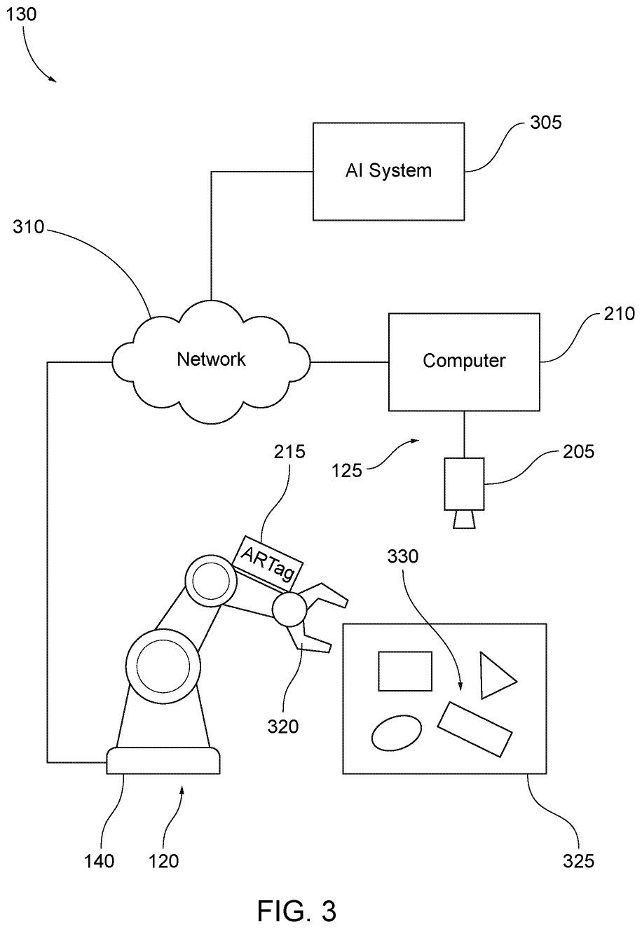

Referring to FIG. 3, one embodiment of the picking facility 130 includes an artificial intelligence system (AI system) 305 in addition to the camera system 125. The AI system 305 is configured to perform a variety of tasks related to material handling. Generally, the artificial intelligence system 305 includes one or more AI and/or machine learning models that are trained to perform such tasks, and the artificial intelligence system 305 is configured to further train the AI and/or machine learning models. In one context, a machine learning model refers to a model that is developed through machine learning processes. In one example, the AI system 305 includes a neural network that is trained to identify objects, track the motion of objects, determine actions of a robot, and/or determine other information about picking and/or placing operations. The AI system 305 is primarily configured to analyze data from images captured by the camera system 125; although, it should be appreciated that the AI system 305 can utilize image data and/or other types of data from other sensors or sources.

The AI system 305 is embodied on one or more computers. For example, AI and/or machine learning models can be stored in the memory of a computer, and a processor of the computer can perform calculations for such algorithms and models. In one embodiment, the artificial intelligence system 305 is embodied on a dedicated computer, such as a remote server, the computer system 105, and/or another computer. In another embodiment, the artificial intelligence system 305 is embodied on the computer 210 of the camera system 125.

As illustrated, the picking facility 130 further includes a network 310 to communicatively connect the components of the picking facility 130. The network 310 may utilize wired, wireless, or a combination of wired and wireless connections to support communication throughout the picking facility 130. Further, the network 310 may connect to and communicate with the wide area network 110 in one embodiment. In this way, the devices in the picking facility 130 are configured to communicate with devices in another facility 115 and/or the computer system 105.

As noted previously, the picking facility 130 includes the robot 120 in the form of the robotic arm 140, and the robotic arm 140 is configured to perform picking and/or placing operations. On a distal end, the robotic arm 140 includes a picking tool 320 that is configured to pick up and release objects. The picking tool 320 is a type of end of arm tool for the robotic arm 140. In one example, the robotic arm 140 is further configured to agitate and/or rearrange the position of objects. As should be appreciated, the picking facility 130 could include other robotic equipment to pick and/or place objects, such as a gantry robot, delta robot, and/or another type of robot. Further, the picking facility 130 could include other robotic equipment to perform different tasks, such as the robotic mast vehicle 145 and/or a robotic shuttle.

The robotic arm 140 is further configured to interact with a tote 325 and items 330. For example, the robotic arm 140 can pick an item 330 from the tote 325, place an item 330 into the tote 325, pick an item 330 from one tote 325 and place the item 330 into another tote 325, and/or perform other actions with one or more totes 325 and items 330. The camera system 125 is configured to send commands to the robotic arm 140 to control picking and/or placing actions. In one embodiment, the robotic arm 140 is configured to receive commands from the artificial intelligence system 305, computer system 105, and/or another device. In one embodiment, the robotic arm 140 includes a computer that controls the movement of the robotic arm 140 and communicates with other parts of the picking facility 130.

In one embodiment, the camera system 125 plans locations for the robotic arm 140 to pick and/or place items 330. In one example, the camera system 125 may determine the location and orientation of an item 330 and then determine a location and orientation for the picking tool 320 to pick that item 330. Similarly, the camera system 125 may determine a desired location and orientation to place the item 330. Further, the camera system 125 determines one or more points on the item 330 for the picking tool 320 to pick the item 330. In another example, the camera system 125 may determine the locations of multiple items 330 and then determine an order for the robotic arm 140 to pick and/or place the items 330. In yet another example, the camera system 125 may determine a specific sequence of movements for the robotic arm 140 to pick and/or place an item 330 based on the location and orientation of the item 330.

The camera system 125 is configured to interface with the artificial intelligence system 305 in order to identify the items 330, determine pick points on the items 330, and/or perform other computer vision tasks. In one example, the artificial intelligence system 305 is embodied on the computer 210 of the camera system 125. The artificial intelligence system 305 is trained at least partially using a static image set of the tote 325 and/or items 330. The static image set includes multiple still images with the tote 325 and/or items 330 in the same position and orientation in each image. The images in the static image set may be collected from multiple frames of a video; although, the same objects and view are maintained in each frame. Similarly, other objects in the background and foreground remain the same in each image within the static image set. In one form, multiple images, such as ten (10) images, of the same static object, which appear to be exactly the same or identical to a human, are incorporated into the training data of the machine learning system. In some examples, two (2) to fifteen (15) of these static object images are used for training, and in other examples, four (4) to ten (10) of these static images are used in training. In another example, at least 10 to material handling system 100 images form the training set. In one particular form, the camera takes ten (10) sequential images in quick succession (e.g., as fast as the shutter speed or refresh rate allows) of the same object under the same environmental conditions. In one instance, the artificial intelligence system 305 is trained using only one static image set of the tote 325 and/or items 330 as training data. In another instance, the artificial intelligence system 305 is trained using multiple static image sets and/or other image data such as to train to identify a wider variety of totes 325 and items 330.

It should be distinguished that the images of the static image set are not simply copies of the same image, but rather the static image set consists of images captured at different instances. By utilizing such images, the camera 205 captures subtle distortions, among other variations, that are used to train the artificial intelligence system 305 to perform in a highly consistent and robust way. In one embodiment, the computer 210 is configured to capture multiple images in quick succession using the camera 205. For example, the computer 210 may capture the images at the framerate of the camera 205, such as at a rate of 24 images per second, 60 images per second, and/or another framerate. In another embodiment, the computer 210 is configured to capture images in a wider or in an irregular interval. As an example, the second image can be taken 1 second after the first image, and the third image or picture is taken 5 seconds after the second image and so on. The camera 205 in one particular example captures 10 images of the scene within less than one second.

Before or during training, the image properties of one or more images in the static image training set are randomly changed. For example, the image properties can include contrast, chrominance, brightness, sharpness, color, saturation, white balance, gamma values, and/or other characteristics. In one embodiment, all or some of the image properties are changed during post-processing after the images are taken. For example, photo editing software can be used, either manually by a human or automatically via a computer, to change the image properties of one or more pictures in the image set. In another version, all or some of these image property changes occur as the photograph or image of the object are actually taken. For example, the brightness of the lights lighting the object is randomly changed as the series of pictures are taken by the camera. A combination of these approaches can be also used in which some image changes occur as the images are captured and others are changed in post-production. Within the static image training set, some or most of the images may remain unchanged. In one version, only 10-20% of the images are randomly changed. For example, when ten images form the training set, only one or two of the images are randomly changed. In another version, about half (40-60%) of the images are randomly changed, and in another version, 80-90% of the images are randomly changed in the training image set. In still yet other versions, all of the images in the training set (i.e., 100%) are changed in some form. Conversely, in other versions, only up to 2% of the images are modified in the training set.

As noted previously, the camera system 125 is configured to apply one or more filters to images captured by the camera 205. In one embodiment, the camera system 125 is configured to filter items 330 that are unpickable from the image based on the size of items 330. In one example, the item 330 may be too large for the picking tool 320 to securely pick. In another example, the item 330 is filtered if a length of the item 330 exceeds twelve inches. In another embodiment, the camera system 125 is configured to filter items 330 that are unpickable due to the position of the items 330. In one example, the item 330 is positioned too close to the side of the tote 325 such that the picking tool 320 cannot securely pick the item 330. In another example, the item 330 is positioned such that a portion of the robotic arm 140 would intersect another robotic arm 140, tote 325, and/or other equipment during picking operations. In such examples, the camera system 125 may remove the unpickable items 330 from the image, black-out the unpickable items 330, and/or change other aspects of the image data associated with the unpickable items 330.

In one embodiment, the camera system 125 limits the movement of the robotic arm 140 to avoid singularities. For example, the robotic arm 140 may not be capable of moving to a certain position due to the shape of segments and joints on the robotic arm 140. In another example, computing the steps for the robotic arm 140 to move to a certain position causes a mathematical error on the computer 210, artificial intelligence system 305, and/or another computer. The camera system 125 may determine movements for the robotic arm 140 that avoid such positions. In another embodiment, the artificial intelligence system 305 is configured to determine paths of movement for the robotic arm 140 that avoid such singularities.

The camera system 125 is configured to interface with the AI system 305 in order to analyze images and determine actions for the robotic arm 140. For example, the camera system 125 may utilize the AI system 305 to identify objects, determine pick locations, determine paths of motion for the robotic arm 140, and/or determine other information from the images. In one embodiment, the camera system 125 sends image data to the artificial intelligence system 305, and a neural network on the artificial intelligence system 305 computes an output based on the image data. In one embodiment, the camera system 125 processes the image data before sending the image data to the artificial intelligence system 305. For example, the camera system 125 may apply a filter to the image and then send the filtered image to the artificial intelligence system 305.

In the illustrated embodiment, the ARTag 215 is mounted on the robotic arm 140 and positioned near the picking tool 320. Placing the ARTag 215 on the robotic arm 140 can facilitate tracking the position of the robotic arm 140 and picking tool 320 by the camera system 125. For example, the camera system 125 may more accurately identify an initial position of the robotic arm 140 when the ARTag 215 is mounted on or near the ARTag 215. In an alternate embodiment, the ARTag 215 may be mounted on the tote 325 or another object. In one example, the picking facility 130 may include multiple ARTags 215 mounted on the robotic arm 140, picking tool 320, tote 325, and/or another object. For example, one ARTag 215 can be mounted on the picking tool 320 such that the camera system 125 can more easily identify the boundaries of the picking tool 320.

In one embodiment, the camera system 125 calculates a calibration correction factor based on the position of the ARTag 215. For example, the camera system 125 calculates a calibration correction factor that includes the difference in position between the ARTag 215 and the picking tool 320. The camera system 125 is configured to calibrate the robotic arm 140, the picking tool 320, and/or the tote 325 based on the calibration correction factor. For example, the camera system 125 may adjust a calculation about the movement of the picking tool 320, update information about the position of an object, send a command to adjust the position of an object, and/or calibrate operations in another way. Further, the camera system 125 is configured to calibrate picking and/or placing locations for item 330 in the tote 325 based on the calibration correction factor. For example, the camera system 125 may adjust a range for picking/placing locations, update information about unpickable locations in the item 330, determine a new path of movement for the robotic arm 140 to pick/place an item 330, and/or calibrate picking/placing locations in another way.

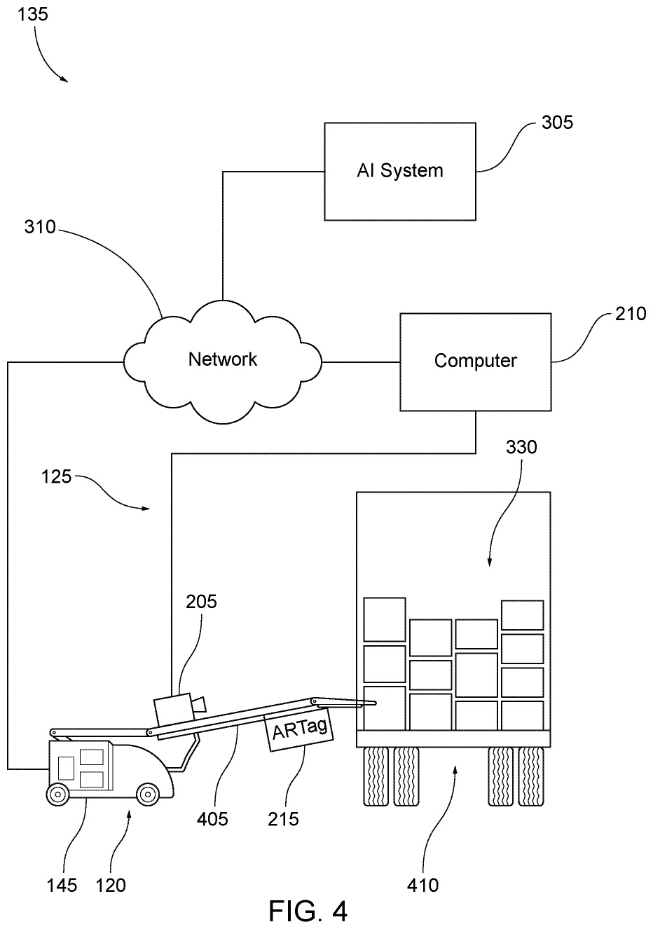

Referring to FIG. 4, one embodiment of the trailer loading facility 135 includes the robot 120, camera system 125, artificial intelligence system 305, and network 310. The robot 120, camera system 125, artificial intelligence system 305, and network 310 of the trailer loading facility 135 in FIG. 4 interact and perform functions in a similar way as in the picking facility 130 of FIG. 3. As noted, the artificial intelligence system 305 is configured to perform a variety of tasks related to material handling using one or more AI and/or machine learning models. The network 310 communicatively connect the components of the trailer loading facility 135 using a wired and/or wireless connection. Further, the network 310 may connect to and communicate with the wide area network 110 in one embodiment. In this way, the devices in the picking facility 130 are configured to communicate with devices in another facility 115 and/or the computer system 105.

As noted previously, the trailer loading facility 135 includes the robot 120 in the form of the robotic mast vehicle 145, and the robotic mast vehicle 145 is configured to perform trailer loading and/or unloading operations. In some cases, the robotic mast vehicle 145 is configured to generally perform picking and/or placing operations. On a distal end, the robotic mast vehicle 145 includes a trailer loading tool 405 that is configured to couple to objects. The trailer loading tool 405 extends from the main body of the robotic mast vehicle 145 and is movable in relation to the rest of the robotic mast vehicle 145. The trailer loading tool 405 is a type of end of arm tool for the robotic mast vehicle 145. In one example, the trailer loading tool 405 includes one or more conveyors, vacuums, grippers, and/or other tools that can couple to and/or move items 330. As should be appreciated, the trailer loading facility 135 could include other robotic equipment to pick and/or place objects, such as a gantry robot, delta robot, and/or another type of robot. Further, the trailer loading facility 135 could include additional robotic equipment to perform different tasks, such as the robotic arm 140 and/or a robotic shuttle. In one specific example, the robotic mast vehicle 145 is an ULTRA BLUE® brand industrial robot which is sold by Bastian Solutions, LLC of Indianapolis, Indiana.

The trailer loading facility 135 further includes a trailer 410 that contains items 330. In one example, the trailer 410 is a semi-truck trailer. In another example, the trailer 410 can be another type of vehicle, a storage platform, and/or another structure that contains items 330. The robotic mast vehicle 145 is configured to load an item 330 into the trailer 410, unload an item 330 from the trailer 410, and/or perform other actions with the items 330 and trailer 410. The camera system 125 is configured to send commands to the robotic mast vehicle 145 to control loading and/or unloading actions. In one embodiment, the robotic mast vehicle 145 is configured to receive commands from the artificial intelligence system 305, computer system 105, and/or another device. In one embodiment, the robotic mast vehicle 145 includes a computer that controls the movement of the robotic mast vehicle 145 and communicates with other parts of the trailer loading facility 135. Similarly to the camera system 125 in the picking facility 130 of FIG. 3, the camera system 125 in the trailer loading facility 135 of FIG. 4 is configured to plan locations for the robotic mast vehicle 145 to load and/or unload items 330. For example, the camera system 125 may determine locations of items 330 within the trailer 410, pick points on the items 330 for the trailer loading tool 405 to couple to the items 330, and/or other key locations for operation of the robotic mast vehicle 145.

In the illustrated embodiment, the camera 205 is mounted to the trailer loading tool 405 to provide a view from the perspective of the trailer loading tool 405. For example, the camera 205 may provide a direct view of the items 330 and a portion of the trailer loading tool 405 from that position. In another instance, the camera 205 can be positioned in the trailer 410 on a different mount or a tripod. The ARTag 215 is also mounted on the trailer loading tool 405 in the illustrated example. In an alternative example, the ARTag 215 is mounted on another part of the robotic mast vehicle 145. Placing the ARTag 215 on the robotic mast vehicle 145 can facilitate tracking the position of the robotic mast vehicle 145 and trailer loading tool 405 by the camera system 125. For example, the camera system 125 may more accurately identify an initial position of the trailer loading tool 405 when the ARTag 215 is mounted on or near the trailer loading tool 405. Alternatively or additionally, one or more ARTags 215 can be mounted within the trailer 410 and/or on the items 330. In a similar way as the camera system 125 in the picking facility 130 of FIG. 3, the camera system 125 in the trailer loading facility 135 of FIG. 4 is configured to calibrate the camera 205 and/or the robotic mast vehicle 145 based on the ARTag 215. For example, the camera system 125 can calculate a calibration correction factor that includes a distance between the camera 205 and the trailer loading tool 405, and can use the calibration correction factor to calibrate one or more devices.

As noted previously, the camera system 125 is configured to interface with the artificial intelligence system 305 in order to perform various computer vision tasks. For example, the artificial intelligence system 305 contains an AI and/or machine learning model that is trained to perform such tasks. In the trailer loading facility 135, the camera system 125 is configured to capture training images of the trailer 410 and items 330 that are used to train the artificial intelligence system 305 for trailer loading/unloading tasks. For example, the artificial intelligence system 305 can be trained to identify and track items 330 in the trailer 410 using such a training set. The camera system 125 is configured to capture multiple static images of the items 330 in the trailer 410. One or more cameras 205 are mounted in a stationary position on the trailer loading tool 405, trailer 410, and/or another structure to maintain a consistent view of the items 330. In one version, the images are taken in rapid succession such that eight to ten images are captured within 1 second or ten images within 0.6 seconds.

Again, the image properties of the static image set are varied. In one example, the image properties are varied naturally, such as through changes to the natural lighting in a static scene. Several trailer 410 types include translucent or semi-translucent roofs so as to provide lighting during the day. Consequently, the lighting within the trailer 410 may change throughout the day due to outdoor conditions and/or conditions within a loading dock as well as the surrounding facility 115. In another version, the camera 205 captures the images using large intervals between consecutive images in a fashion similar to time lapse photography. In one form, the static image set includes twelve images taken over a single day, and the interval between images is about two hours. For example, the camera 205 can capture time lapse images within the trailer 410 over a weekend. In another form, ten images are taken over a ten-hour period at random or irregular intervals. In still yet another form, the intervals between images is at least a half an hour and at most four hours. It should be recognized that other intervals and number of images can be used to form the static image training set. Using a time lapse approach to capturing the images, various natural image properties can change within the image set. For example, image brightness or color within the trailer 410 may naturally change throughout the day. In one version, all of the images in the static image set are not randomly or synthetically changed before being used for training the models. In other words, the image properties in the static image training set remain the same or unchanged from when the camera 205 captures the images. Instead of randomly changing one or more image properties in at least one of the images, the training technique relies on the environmental changes to create the random image property changes. In another variation, one or more of the images in the static image set are manually changed by a human operator or automatically changed via the computer 210 and/or another computer so as to have a further image property changed beside the natural image property changes. For instance, the brightness and/or color saturation in one image of a ten-image training set is randomly changed before being used for training. In some cases, the image properties can be extremely changed so as to make the objects in the changed training image almost unrecognizable. For example, the contrast may be reduced to an extent where a human would have difficulty in distinguishing objects in the image.

With training the robotic arm 140 of FIG. 3, robotic mast vehicle 145 of FIG. 4, and/or other robots 120 in other facilities 115, the camera system 125 is configured to transfer the static image set to an AI and/or machine learning model on the artificial intelligence system 305 and/or another device. The static image set is added to a larger set of training data. In one form, the training data set includes the static image training set from the camera system 125 and/or other static image training sets from other camera systems 125 at different robots 120, and the training data set further includes images from other sources besides those that use the static image sampling technique. For instance, stock images and/or single images of the same or different objects can be incorporated. In one form, the static training images from the camera system 125 represent at most 10% of the images in the overall set of training data for training the AI and/or machine learning model, and in further forms, the static training images represent at most 1% to 2% of the training data set. In another example, the static image training sets form about half (e.g., 40% to 60%) of the training data set. In still yet other selected examples, the static image training sets form most (e.g., 80%) or all (i.e., 100%) of the training data set.

Before or after being incorporated into the set of training data, the camera system 125 is configured to change the image properties of at least one of the images in the static image training set. In some cases, the camera system 125 can rely on natural changes to the properties of the static images, for example through the time lapse example for the robotic mast vehicle 145 and trailer 410. In most cases, however, the image properties of these selected images are actively changed, either manually by a human or automatically by a computer. For example, the machine learning system automatically changes one or more image properties of one or more images within the static image training set. In some cases, 1% to 2% of the images within the static image training set are changed automatically via the computer. For instance, when the static image training set includes 10 images, then the image properties of one or two of the images are randomly changed. In the computer of one version, a random number generator, such as via a seed value, generates one or more random numbers for determining which image to change and which image properties to change as well as to the extent of the changes.

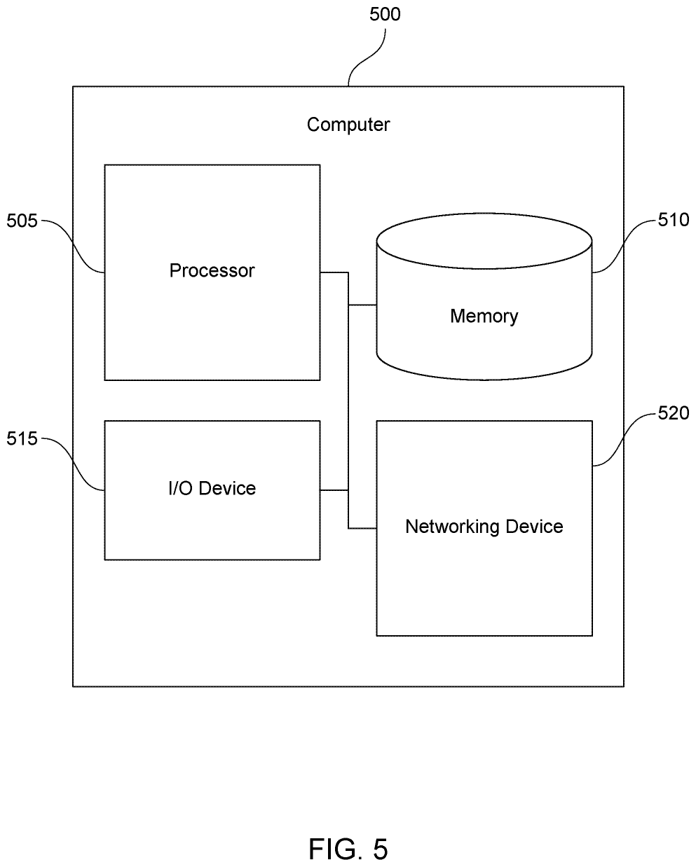

FIG. 5 illustrates one embodiment of a computer or computer 500 that can be used in the facility 115, picking facility 130, and/or trailer loading facility 135 of FIGS. 1, 2, 3, and 4. For example, the depicted computer 500 can be incorporated into the artificial intelligence system 305 and/or robotic arm 140 of the picking facility 130 in FIG. 3. In one form, the artificial intelligence system 305, network 310, and robotic arm 140 include the computer 500. The computer 500 generally includes at least one processor 505, memory 510, input/output device (I/O device) 515, and network interface 520. The processor 505, memory 510, I/O device 515, and network interface 520 are all connected and configured to communicate with one another. One or more parts of the material handling system 100 include a computer 500. For example, the computer system 105, wide area network 110, camera system 125, computer 210, artificial intelligence system 305, network 310, robotic arm 140, and/or another part of the material handling system 100 may include one or more computers 500.

The processor 505 is configured to perform calculations and/or other computational tasks. For example, the processor 505 may train, test, and/or validate an AI model. In another example, the processor 505 may perform an algorithm that involves one or more AI models. The memory 510 is configured to store data, algorithms, and/or other information. For example, the memory 510 may store data used for training, testing, and/or validating AI models. In another example, the memory 510 may store machine learning algorithms and/or AI models that have been developed through machine learning.

The I/O device 515 is configured to provide an interface between the computer 500 and various external devices. For example, the I/O device 515 may connect a computer 500 to one or more cameras 205, robotic arms 140, and/or other devices. The I/O device 515 is configured to support communication between the computer 500 and such devices. For example, the computer 500 may directly send and/or receive data, commands, and/or other information using the I/O device 515. Similarly, the network interface 520 is configured to provide an interface between the computer 500 and various networks. For example, the network interface 520 may connect the computer 500 to the wide area network 110 and/or network 310. The network interface 520 is configured to support communication between the computer 500 and such networks. For example, the computer 500 may send and/or receive data, commands, and/or other information across one or more networks using the network interface 520. The network interface 520 may support wired and/or wireless connections.

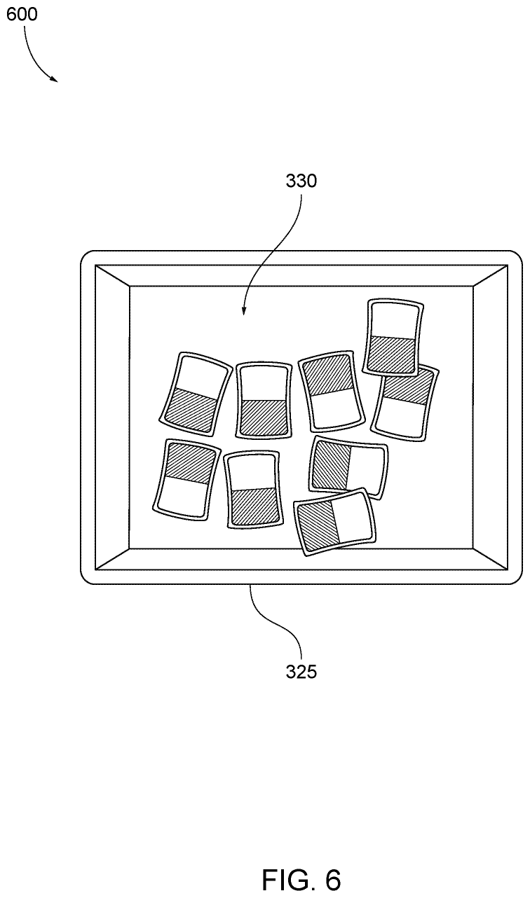

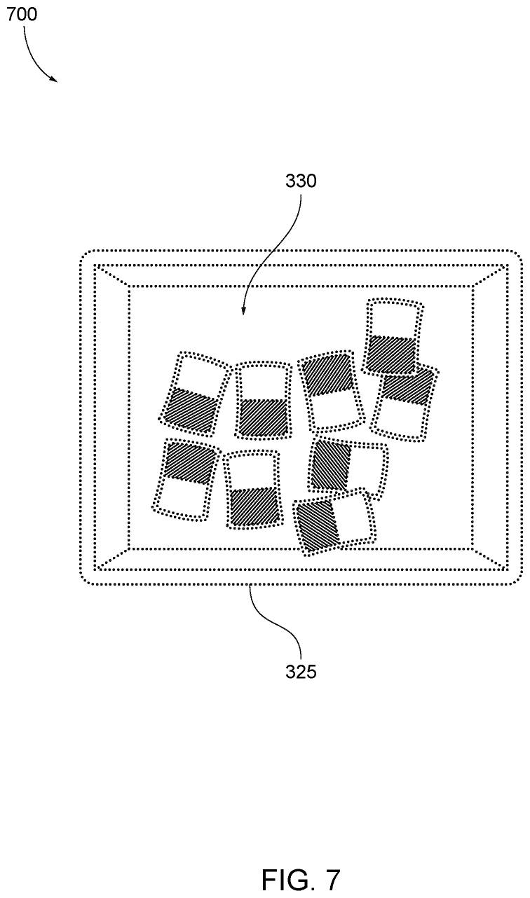

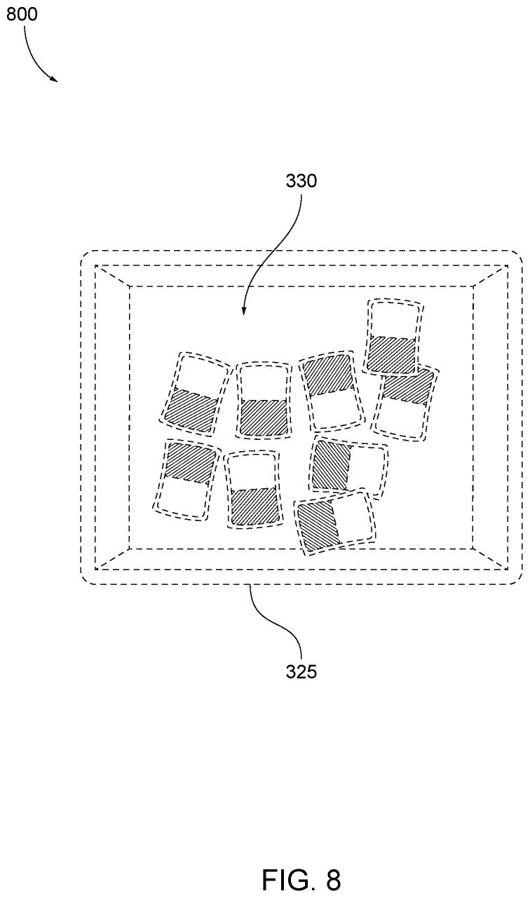

Referring to FIGS. 6, 7, and 8, the camera system 125 is configured to capture multiple images of the same scene. In the shown examples, the camera system 125 captures a first tote image 600, a second tote image 700, and a third tote image 800 of one tote 325 containing items 330, such as in the picking facility 130 of FIG. 3. The ordering of the images refers to the order as presented, and the images are not necessarily captured in that order in time. In one embodiment, the camera system 125 is configured to change image properties of images captured by the camera 205. In one example, the camera system 125 changes settings of the camera 205 while capturing multiple images of a scene. In one embodiment, the camera system 125 is configured to randomly change a setting of the camera 205 within a pre-determined range. For example, the camera system 125 may change a setting of the camera 205 to a random value after capturing one image and before capturing another image.

In another form, the camera system 125 is configured to change the image properties of the static image set in post-processing. For instance, the camera system 125 automatically changes an image property using the computer 210 and/or a human operator changes an image property manually. The camera system 125 can change the image properties randomly or can change the image properties based on certain reasons. In one example, the camera system 125 selects an image with an image property at an extreme value relative to other image properties of other images, and the camera system 125 changes that image property such as to further exaggerate the image property. In another example, the camera system 125 only varies image properties for a portion of the static image set, such as for less than 10%, less than 40%, less than 50%, less than 80%, and/or less than 90% of the images in the static image set.

By changing the image properties, the first tote image 600, second tote image 700, and third tote image 800 all appear differently. As one example, the brightness is greater in the first tote image 600 than the third tote image 800 and is greater in the second tote image 700 than the first tote image 600. The brightness may vary due to changes in a general brightness property in post-processing; due to changes in camera settings such as aperture, shutter speed, gain, and/or neutral density filter; and/or due to post-processing changes in other image properties such as the tint, contrast, saturation, focus, sharpness, resolution, and/or any other settings that affect the image characteristics. As should be appreciated, lighting conditions of the facility 115 can also be varied to affect characteristics of the images. For example, the intensity, angle, color, distribution, and/or other qualities of natural and/or artificial lighting may vary between images. Further, in some cases, there are differences between the first tote image 600, second tote image 700, and third tote image 800 that are imperceptible to a human. For example, electrical flickering, heat vapors, mirages, and/or other minute or random environmental factors can cause changes in the first tote image 600, second tote image 700, and third tote image 800 that only a computer vision system might perceive. In another example, the changes could be due to differences in the invisible portion of the light spectrum, such as differences in ultraviolet or infrared light that the camera 205 captures but that are imperceptible to humans.

Conversely, as depicted, the positioning and view of the tote 325 and items 330 stay the same in each image. Further, the background is consistent between images. By maintaining the same scene, the camera system 125 is configured to identify the tote 325, items 330, and/or other objects in the scene despite changes in the image quality and characteristics. For example, the camera system 125 may correctly identify the same objects when one camera 205 is replaced with a different camera 205. In another example, the camera system 125 may correctly identify the same objects as the lighting conditions in the facility 115 change throughout the day.

As noted previously, the camera system 125 is configured to communicate with the artificial intelligence system 305. The artificial intelligence system 305 is configured to identify objects based on the captured images. In one embodiment, the artificial intelligence system 305 is trained based on a static image set containing multiple images with different image properties. For example, the artificial intelligence system 305 may be trained to identify items 330, determine the position and orientation of items 330, identify the bounds of the tote 325, and/or perform other computer vision tasks based on a set of such images. In one embodiment, the artificial intelligence system 305 is trained using images captured by the camera 205 in successive frames. For example, the camera system 125 may capture multiple images within a period shorter than ten seconds and subsequently vary the image properties. In an alternate embodiment, the camera system 125 is configured to capture images at various points throughout the day which are used to train the artificial intelligence system 305.

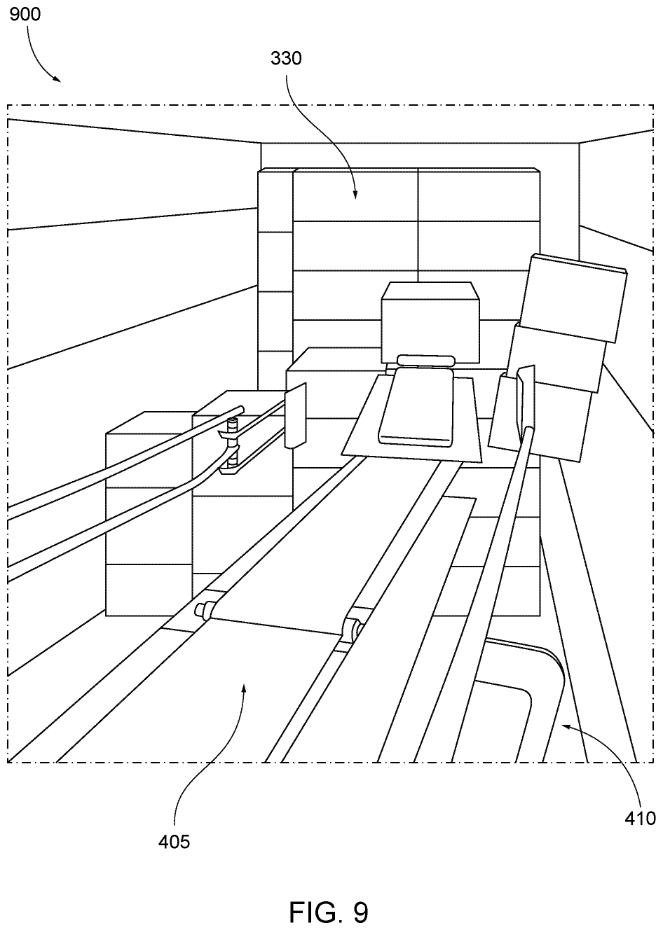

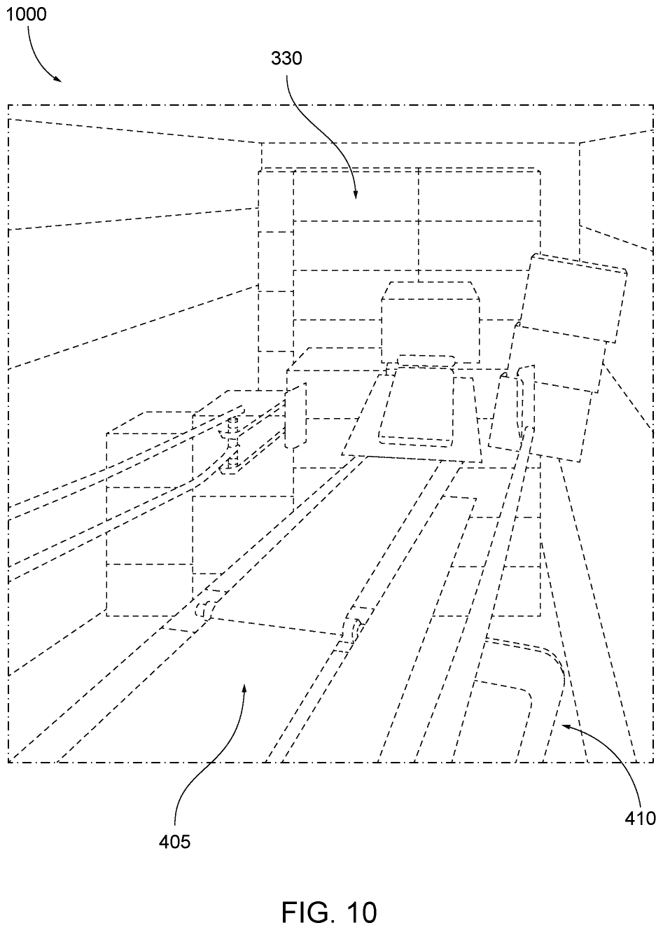

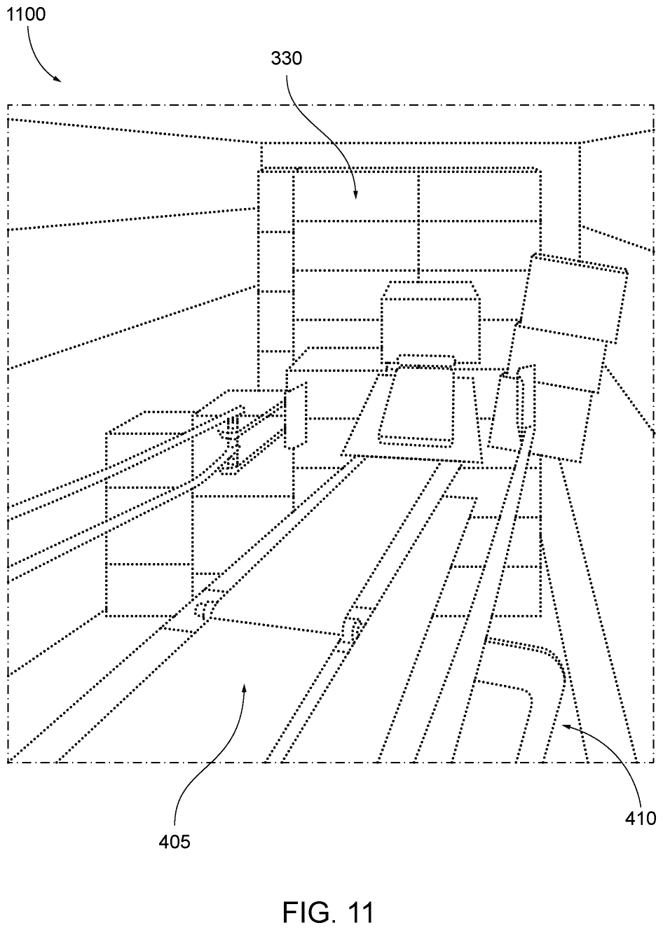

Referring to FIGS. 9, 10, and 11, the camera system 125 is configured to capture multiple static training images in the trailer loading facility 135. In the shown examples, the camera system 125 captures a first trailer image 900, a second trailer image 1000, and a third trailer image 1100 of the trailer loading tool 405 and of the trailer 410 containing items 330, such as in the trailer loading facility 135 of FIG. 4. The ordering of the images refers to the order as presented, and the images are not necessarily captured in that order in time. In one embodiment, the camera system 125 is configured to change image properties of images captured by the camera 205. In one example, the camera system 125 changes settings of the camera 205 while capturing multiple images of a scene. In one embodiment, the camera system 125 is configured to randomly change a setting of the camera 205 within a pre-determined range. For example, the camera system 125 may change a setting of the camera 205 to a random value after capturing one image and before capturing another image.

In another form, the camera system 125 is configured to change the image properties of the static image set in post-processing. For instance, the camera system 125 automatically changes an image property using the computer 210 and/or a human operator changes an image property manually. The camera system 125 can change the image properties randomly or can change the image properties based on certain reasons. In one example, the camera system 125 selects an image with an image property at an extreme value relative to other image properties of other images, and the camera system 125 changes that image property such as to further exaggerate the image property. In another example, the camera system 125 only varies image properties for a portion of the static image set, such as for less than 10%, less than 40%, less than 50%, less than 80%, and/or less than 90% of the images in the static image set.

In yet another form, the camera system 125 is configured to passively change the image properties through changes in the facility 115 environment. In some cases, changes in the lighting of the facility 115 can cause the most change in image properties, such as changes in the natural lighting, deliberate changes in artificial lighting, and/or unpredictable flickering or oscillations in the lighting conditions as a few examples. The images capture differences due to other factors in the facility 115 environment, such as glares, mirages, and/or distortions caused by air pressure differences, heat, vapors, reflections, and/or other various conditions. By capturing the images at different times, the images capture any variations in such effects. For some variations, the images only capture the variation due to differences in the environment. To clarify, post-processing cannot be used to change image properties such as to achieve certain environmental effects in the captured images.

Again, by changing the image properties, the first trailer image 900, second trailer image 1000, and third trailer image 1100 all appear differently. As one example, the brightness is greater in the second trailer image 1000 than the first trailer image 900 and is greater in the first trailer image 900 than the third trailer image 1100. The brightness may vary due to changes in a general brightness property in post-processing; due to changes in camera settings such as aperture, shutter speed, gain, and/or neutral density filter; and/or due to post-processing changes in other image properties such as the tint, contrast, saturation, focus, sharpness, resolution, and/or any other settings that affect the image characteristics. As should be appreciated, lighting conditions of the trailer loading facility 135 and trailer 410 can also be varied to affect characteristics of the images. For example, the intensity, angle, color, distribution, and/or other qualities of natural and/or artificial lighting may vary between images. In one version, the images are captured at different points throughout the day, such that the natural lighting conditions in the trailer 410 vary. The brightness and other image properties can change between images due to the environmental changes, such as contrast, saturation, sharpness, and/or other properties. Further, in some cases, there are differences between the first trailer image 900, second trailer image 1000, and third trailer image 1100 that are imperceptible to a human. For example, electrical flickering, heat vapors, mirages, and/or other minute or random environmental factors can cause changes in the first trailer image 900, second trailer image 1000, and third trailer image 1100 that only a computer vision system might perceive. In another example, the changes could be due to differences in the invisible portion of the light spectrum, such as differences in ultraviolet or infrared light that the camera 205 captures but that are imperceptible to humans.

Conversely, as depicted, the positioning and view of the trailer loading tool 405, trailer 410, and items 330 stay the same in each image. By maintaining the same scene, the camera system 125 is configured to identify the trailer loading tool 405, trailer 410, items 330, and/or other objects in the scene despite changes in the image quality and characteristics. For example, the camera system 125 may correctly identify the same objects when one camera 205 is replaced with a different camera 205. In another example, the camera system 125 may correctly identify the same objects as the lighting conditions in the facility 115 change throughout the day.

As noted previously, the camera system 125 is configured to communicate with the artificial intelligence system 305. The artificial intelligence system 305 is configured to identify objects based on the captured images. In one embodiment, the artificial intelligence system 305 is trained based on a static image set containing multiple images with different image properties. For example, the artificial intelligence system 305 may be trained to identify items 330, determine the position and orientation of items 330, identify the bounds of the tote 325, and/or perform other computer vision tasks based on a set of such images. In one embodiment, the artificial intelligence system 305 is trained using images captured by the camera 205 in successive frames. For example, the camera system 125 may capture multiple images within a period shorter than ten seconds and subsequently vary the image properties. In an alternate embodiment, the camera system 125 is configured to capture images at various points throughout the day which are used to train the artificial intelligence system 305.

The following techniques are generally described as being performed by the camera system 125. As should be appreciated, various actions of these techniques are performed by the appropriate parts of the camera system 125, such as the camera 205 and computer 210. For example, the camera 205 may capture images and the computer 210 may process the images in some way, but camera system 125 may be described as performing such actions. Further, some or all of the actions can be performed by another device in the material handling system 100. For example, the computer system 105, artificial intelligence system 305, computer 500, and/or another device may perform one or more actions in the following techniques. As should be recognized, parts of computers on the computer system 105, artificial intelligence system 305, and/or another device perform the appropriate parts of an action. As an example, the processor 505 may perform training and testing on a machine learning model using training data and the memory 510 may store the training and testing data, but the computer 500 can be described as generally performing the actions.

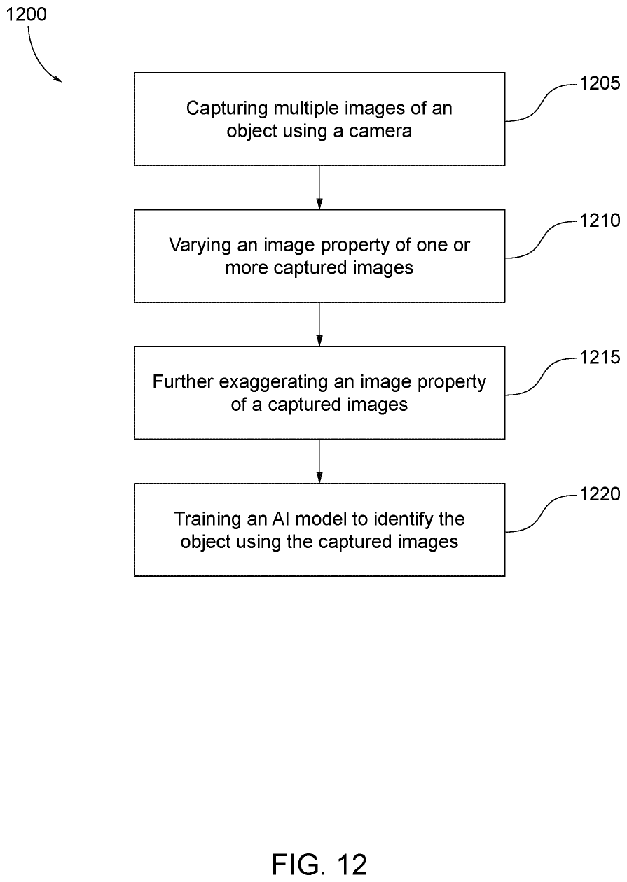

Referring to FIG. 12, the camera system 125 is configured to perform a method 1200 for training a machine learning model on the artificial intelligence system 305. At stage 1205, one or more cameras 205 record images of an object to form a static image set. As previously shown in FIGS. 6, 7, and 8, the object can include the tote 325 and the item 330. In another example, the object includes the robot 120, picking facility 130, robotic arm 140, trailer 410, and/or objects used for other material handling scenarios. As shown in the tote image set of FIGS. 6, 7, and 8 and in the trailer image set of FIGS. 9, 10, and 11, the images are static for each set. Specifically, the objects in the images and the view of the images is maintained for each image that is captured in the static image set. The objects are stationary for the duration that the camera system 125 is capturing images.

In some examples, the camera system 125 captures two to fifteen of these static object images to be used for training, and in other examples, the camera system 125 captures four to ten of these static images for training. In another example, the camera system 125 captures at least ten to one hundred images to form a static image set. In one particular form, the camera takes ten images in quick succession. In another form, the images are taken as separate frames from a video recording. As the camera system 125 captures the images, there is a time interval between capturing successive images. In one version, the images are taken at regular intervals. For example, the camera system 125 can capture images at the speed of the framerate of the camera 205, such as at 1/24 second intervals, 1/60 second intervals, or another speed. In another example, the interval between images is evenly spaced within an image capturing period. For instance, the camera system 125 captures all images within 1 second, within 10 seconds, within 15 seconds, or another period of time. In yet another example, the interval is much longer than the framerate of the camera 205, such as 1 hour, 2 hours, 4 hours, 1 day, and/or another period of time. Using a longer interval, the camera system 125 can capture images that show long term and/or periodic changes in the facility 115, such as in the form of a time lapse. In another version, the images are captured irregular or random intervals. As an example, the second image can be taken 1 second after the first image, and the third image or picture is taken 5 seconds after the second image and so on. In one particular example, the camera 205 captures 10 images of the scene within less than one second. It should be recognized that other intervals can be used and a different number of images can be taken.

From stage 1205, the camera system 125 proceeds to stage 1210. At stage 1210, the camera system 125 varies an image property of one or more images captured during stage 1205. In one version, the computer 210 on the camera system 125 processes the images after the camera 205 captures the images. The computer 210 varies the image properties automatically through software or based on manual inputs from a human operator. In one example, the camera system 125 randomly varies the image properties within a predetermined range during post-processing. The image properties can include contrast, chrominance, brightness, sharpness, color, saturation, white balance, and gamma values, to name just a few. In another version, the camera system 125 changes a setting on the camera 205 that causes changes to the properties of the captured images. As another example, the computer 210 may randomly select a new value for the setting from a predetermined range of values. In one embodiment, the setting includes focus, shutter speed, ISO, sharpness, resolution, and/or another setting on the camera 205. The settings are configurable to change during the interval between capturing each image.

In yet another version, the camera system 125 captures images with varied image properties in a passive way. Because the images are captured at different times, some environmental factors vary between the multiple images. For example, the brightness of the images can change when lighting in the facility 115 changes, for example through preplanned changes to artificial lighting, random variations in artificial lighting, cyclical changes in natural lighting, and/or other lighting changes. In one example, the lighting is set to a random level at each interval between capturing each image. In another example, the interval is timed such that the images capture differences in natural lighting throughout a day. The environmental factors can further cause imperceptible or nearly imperceptible effects on the image properties. Such effects are typically imperceptible to humans but can be noticed by the camera system 125 and machine learning models. For instance, imperceptible thermal gradients in a workspace may slightly change the index of refraction of air such that mirages and/or heat haze is created that is imperceptible to humans. As another example, the lighting environment, such as in the case of fluorescent lights or fluctuations in the power supply frequency, may cause the light brightness levels to ever so slightly fluctuate (e.g., strobe). The camera 205 may also cause these slight changes in image properties. For example, noise within the image sensor of the camera 205 may create stray pixels or noise. As should be appreciated, the camera system 125 can vary the image properties through post-processing, camera settings, allowing the environment to vary, and/or through a combination of any of the discussed options.

The camera system 125 varies the image properties for all images in the static image set or for only a portion of the images. In one instance, some or most of the images in the static image set may remain unchanged. In one version, only 10-20% of the images are randomly changed. For example, when ten images form the training set, only one or two of the images are randomly changed. In another version, about half (40-60%) of the images are randomly changed, and in another version, 80-90% of the images are randomly changed in the training image set. In still yet other versions, all of the images in the training set (i.e., 100%) are changed in some form.

The camera system 125 optionally proceeds to stage 1215. At stage 1215, the camera system 125 further exaggerates an image property of one of the captured static images. In one form, the camera system 125 utilizes post-processing to further change an image property. For instance, the static image set may include the original properties of the images as the images were captured in stage 1205, and the camera system 125 may change an image property for an outlier image in the static image set. Alternatively, the camera system 125 may randomly vary the image properties during stage 1210 and then change an image property or an outlier image in the static image set. In other words, the system compares the images within the static image training set to find at least one image with one or more image properties that deviate the most from the rest of the images, and the system further distorts the outlier image based on the outlier properties. As an example, the camera system 125 can determine an average brightness for the static images along with a standard deviation within the static image set. The camera system 125 can identify the image with the highest brightness deviation and then distort the image further by increasing or decreasing the image brightness by some percentage, standard deviation value (e.g., three sigma), and/or in other manners. For instance, if the overall brightness of the image is less than the average, the brightness of the image is reduced by say 50%. By further distorting these outlier images and/or image properties, while not certain, it is theorized that this approach may identify image properties that require desensitization on the part of AI model and the artificial intelligence system 305.

At stage 1220, the camera system 125 trains the artificial intelligence system 305 to identify the objects in the captured images. As should be appreciated, the camera system 125 may train a machine learning model on another device at stage 1220, such as the computer system 105, computer 210, and/or another device including a computer 500. For example, the artificial intelligence system 305 includes a neural network and the camera system 125 uses a machine learning algorithm to train the neural network based on the training data. The neural network can include a convolutional neural network, a recurrent neural network, a generative network, a discriminative network, and/or another type of neural network. In one embodiment, the training data includes labels based on the object in the image. In another embodiment, the camera system 125 communicates the image data and/or training instructions to the artificial intelligence system 305 to train an AI model. In yet another embodiment, the artificial intelligence system 305 is trained to perform additional tasks including tracking the position of objects, identifying the orientation of objects, and/or other computer vision tasks. The training methods used by the artificial intelligence system 305 include supervised learning, unsupervised learning, and/or reinforcement learning approaches.

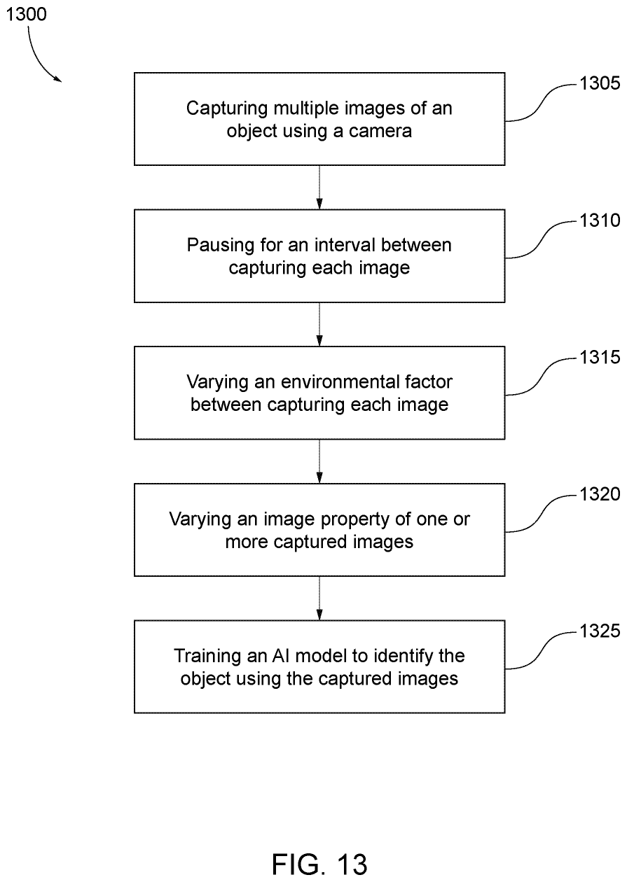

Referring to FIG. 13, the camera system 125 is configured to perform a method 1300 for training a machine learning model on the artificial intelligence system 305. In some embodiments, the method 1300 can be performed by the camera system 125 in a similar way to the method 1200. At stage 1305, one or more cameras 205 record images of an object to form a static image set. As previously shown in FIGS. 6, 7, and 8, the object can include the tote 325 and the item 330. In another example, the object includes the robot 120, picking facility 130, robotic arm 140, trailer 410, and/or objects used for other material handling scenarios. As shown in the tote image set of FIGS. 6, 7, and 8 and in the trailer image set of FIGS. 9, 10, and 11, the images are static for each set. Specifically, the objects in the images and the view of the images is maintained for each image that is captured in the static image set. The objects are stationary for the duration that the camera system 125 is capturing images. In some examples, the camera system 125 captures two to fifteen of these static object images to be used for training, and in other examples, the camera system 125 captures four to ten of these static images for training. In another example, the camera system 125 captures at least ten to one hundred images to form a static image set. In one particular form, the camera takes ten images in quick succession. In another form, the images are taken as separate frames from a video recording.

While performing the actions of stage 1305, the camera system 125 proceeds to stage 1310. As the camera system 125 captures the images, there is a time interval between capturing successive images. In one version, the images are taken at regular intervals. For example, the camera system 125 can capture images at the speed of the framerate of the camera 205, such as at 1/24 second intervals, 1/60 second intervals, or another speed. In another example, the interval between images is evenly spaced within an image capturing period. For instance, the camera system 125 captures all images within 1 second, within 10 seconds, within 15 seconds, or another period of time. In yet another example, the interval is much longer than the framerate of the camera 205, such as 1 hour, 2 hours, 4 hours, 1 day, and/or another period of time. Using a longer interval, the camera system 125 can capture images that show long term and/or periodic changes in the facility 115, such as in the form of a time lapse. For example, the interval is timed such that the images capture differences in natural lighting throughout a day. In another version, the images are captured at irregular or random intervals. As an example, the second image can be taken 1 second after the first image, and the third image or picture is taken 5 seconds after the second image and so on. In one particular example, the camera 205 captures 10 images of the scene within less than one second. It should be recognized that other intervals can be used and a different number of images can be taken. By pausing for a time interval, the camera system 125 allows for various image properties to change naturally while capturing the images.

Also while performing the actions of stage 1305, the camera system 125 proceeds to stage 1315. At stage 1315, one or more environmental factors in the facility 115 change such that the image properties change as a result. For example, the camera system 125 can instruct lighting and/or other equipment in the facility 115 to change in order to affect the image properties. In one version, the camera system 125 changes lighting in the facility 115 within a random range such that the brightness is random in each captured static image. Other environmental factors can further cause imperceptible or nearly imperceptible effects on the image properties. Such effects are typically imperceptible to humans but can be noticed by the camera system 125 and machine learning models. For instance, imperceptible thermal gradients in a workspace may slightly change the index of refraction of air such that mirages and/or heat haze is created that is imperceptible to humans. As another example, the lighting environment, such as in the case of fluorescent lights or fluctuations in the power supply frequency, may cause the light brightness levels to ever so slightly fluctuate (e.g., strobe). The camera 205 may also cause these slight changes in image properties. For example, noise within the image sensor of the camera 205 may create stray pixels or noise. In one form, the camera system 125 purposefully instructs various equipment to operate in a certain way to change such imperceptible factors. For example, the camera system 125 may alter the activity of high-powered equipment to affect the extent of electrical flickering, affect heat released in the air of the facility 115, and/or affect other such factors. As another example, the camera system 125 may alter operational properties of the camera such as to affect image noise and/or cause other variations in the images.

After or during stage 1315, the camera system 125 proceeds to stage 1320. At stage 1320, the camera system 125 varies an image property of one or more images captured during stage 1305. In one version, the computer 210 on the camera system 125 processes the images after the camera 205 captures the images. The computer 210 varies the image properties automatically through software or based on manual inputs from a human operator. In one example, the camera system 125 randomly varies the image properties within a predetermined range during post-processing. The image properties can include contrast, chrominance, brightness, sharpness, color, saturation, white balance, and gamma values, to name just a few. In another version, the camera system 125 changes a setting on the camera 205 that causes changes to the properties of the captured images. As another example, the computer 210 may randomly select a new value for the setting from a predetermined range of values. In one embodiment, the setting includes focus, shutter speed, ISO, sharpness, resolution, and/or another setting on the camera 205. The settings are configurable to change during the interval between capturing each image.

The camera system 125 varies the image properties for all images in the static image set or for only a portion of the images. In one instance, some or most of the images in the static image set may remain unchanged. In one version, only 10-20% of the images are randomly changed. For example, when ten images form the training set, only one or two of the images are randomly changed. In another version, about half (40-60%) of the images are randomly changed, and in another version, 80-90% of the images are randomly changed in the training image set. In still yet other versions, all of the images in the training set (i.e., 100%) are changed in some form.

The camera system 125 optionally further exaggerates an image property of one of the captured static images. In one form, the camera system 125 utilizes post-processing to further change an image property. For instance, the static image set may include the original properties of the images as the images were captured in stage 1205, and the camera system 125 may change an image property for an outlier image in the static image set. In other words, the system compares the images within the static image training set to find at least one image with one or more image properties that deviate the most from the rest of the images, and the system further distorts the outlier image based on the outlier properties. As an example, the camera system 125 can determine an average brightness for the static images along with a standard deviation within the static image set. The camera system 125 can identify the image with the highest brightness deviation and then distort the image further by increasing or decreasing the image brightness by some percentage, standard deviation value (e.g., three sigma), and/or in other manners. For instance, if the overall brightness of the image is less than the average, the brightness of the image is reduced by say 50%. By further distorting these outlier images and/or image properties, while not certain, it is theorized that this approach may identify image properties that require desensitization on the part of AI model and the artificial intelligence system 305.

At stage 1325, the camera system 125 trains the artificial intelligence system 305 to identify the objects in the captured images. Training at stage 1325 may be performed in the same or similar way to training at stage 1220 in FIG. 12. As should be appreciated, the camera system 125 may train a machine learning model on another device at stage 1320, such as the computer system 105, computer 210, and/or another device including a computer 500. For example, the artificial intelligence system 305 includes a neural network and the camera system 125 uses a machine learning algorithm to train the neural network based on the training data. The neural network can include a convolutional neural network, a recurrent neural network, a generative network, a discriminative network, and/or another type of neural network. In one embodiment, the training data includes labels based on the object in the image. In another embodiment, the camera system 125 communicates the image data and/or training instructions to the artificial intelligence system 305 to train an AI model. In yet another embodiment, the artificial intelligence system 305 is trained to perform additional tasks including tracking the position of objects, identifying the orientation of objects, and/or other computer vision tasks. The training methods used by the artificial intelligence system 305 include supervised learning, unsupervised learning, and/or reinforcement learning approaches.

Before using the image data to train the artificial intelligence system 305 at both stage 1325 in FIG. 13 and at stage 1220 in FIG. 12, the camera system 125 transfers the static image set data to the artificial intelligence system 305 to incorporate the static image set into a much larger set of training data. In one form, the training data set includes the static image training set from the camera 205 at the robotic arm 140 and/or other static image training sets from other camera 205 at different robots 120. The training data set can further include images from other sources besides those captured in stage 1305. For instance, stock images and/or single images of the same or different objects can be incorporated. In one form, the static training images from the camera system 125 represent at most 10% of the images in the overall set of training data for training the machine learning models of the artificial intelligence system 305, and in further forms, the static training images represent at most 1% to 2% of the training data set. In another example, the static image training sets form about half (e.g., 40% to 60%) of the training data set. In still yet other selected examples, the static image training sets form most (e.g., 80%) or all (i.e., 100%) of the training data set.

By training the artificial intelligence system 305 based on the static image training set, the artificial intelligence system 305 is configured to correctly identify objects from images that are captured using a wide variety of camera types, camera settings, and/or environmental conditions. In one specific example, training the artificial intelligence system 305 in this method allows the artificial intelligence system 305 to incorporate one or more human imperceptible image properties into a computer vision model. For example, the artificial intelligence system 305 may falsely identify a portion of an image signal as being indicative or not of some object. During use, the presence of one or more of these human imperceptible image qualities may trigger the artificial intelligence system 305 to not recognize a physically present object or conversely imagine a phantom, nonexistent object. By being exposed to a series of extremely similar images in the static image training set with one or more having the image properties changed, the artificial intelligence system 305 learns to ignore and/or becomes immune to any spurious human imperceptible changes in the image.

Once the training is complete, the AI model can be transmitted to one or more robots 120, such as the robotic arm 140, the robotic mast vehicle 145, a robotic shuttle, a gantry robot, and/or other robots 120. The AI model can be trained for picking-placing, loading-unloading, and/or other activities performed by the robots 120. This technique is quite adaptable to a wide variety of computer vision activities. For instance, this technique is not limited to a specific type of camera 205 and/or type of facility 115. Moreover, it has been found that this training technique considerably reduces issues with operating the robot 120 and camera system 125. For example, this technique can reduce false positives or negatives for object detection.

In addition to training robots 120 for material handling activities, this machine learning training technique and system can be used in a wide variety of scenarios where computer vision object detection is used. This training technique can be universally applicable in that the camera 205 used to generate the training data may not be the same one that utilizes the learned object detection models. In other words, the object detection ability created by the static image training data can be used in multiple object detection environments and with different cameras 205 as well as other different equipment than was used to create the static training images in the first place. For example, this technique and system can be used to train autonomous vehicles.

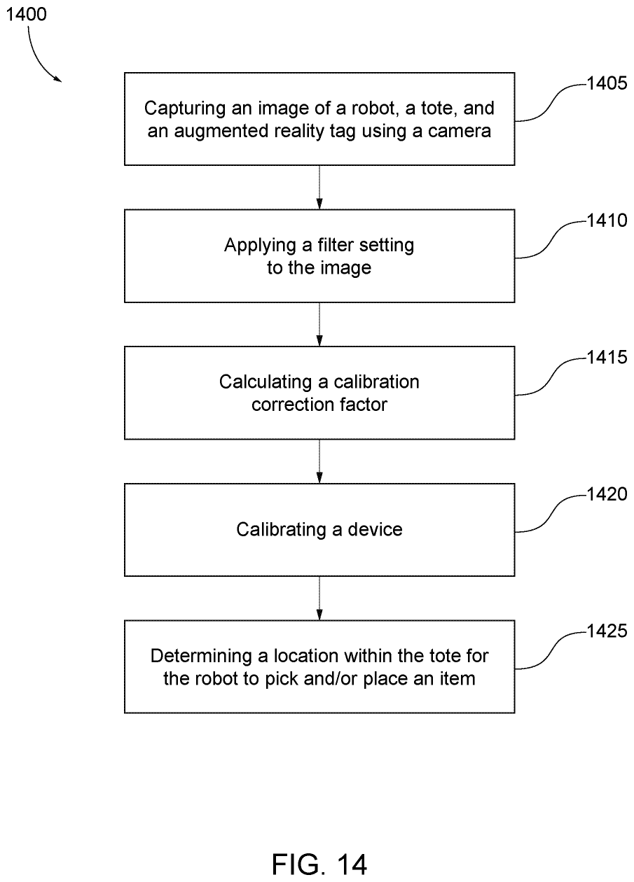

Referring to FIG. 14, a method 1400 demonstrates a technique for operating the camera system 125. The method 1400 is generally described for operating the camera system 125 within the picking facility 130 and in relation to the robotic arm 140 of FIG. 3. As should be appreciated, the method 1400 could be performed in the same or similar way within the trailer loading facility 135 of FIG. 4 or a different material handling environment. Further, the method 1400 can be performed in relation to a variety of types of robots 120, such as the robotic mast vehicle 145 of FIG. 4, a gantry style robot, a robotic shuttle, and/or another robot. At stage 1405, one or more cameras 205 capture an image of the ARTag 215, robot 120, and tote 325. For example, the camera 205 may capture an image of the picking facility 130 illustrated in FIG. 3. In one example, the camera 205 includes multiple 2D cameras and/or a 3D camera such as to obtain information about the three-dimensional shape and positioning of the objects.

After stage 1405, the camera system 125 optionally proceeds to stage 1410. At stage 1410, the camera system 125 applies a filter to the captured image. The filter is configured to alter the image based on considerations for picking and/or placing operations. In one embodiment, the filter removes items 330 from the image if the items 330 are unpickable by the picking facility 130. For example, the camera systems 125 may determine an item 330 is unpickable based on the size and/or position of the item 330 within the tote 325 and then apply a filter to the item 330 in the image.

The camera system 125 then proceeds to stage 1415. At stage 1415, the camera system 125 calculates a calibration correction factor. The calibration correction factor is based on the position of the ARTag 215. In one example, the camera system 125 calculates the calibration correction factor based on a difference in position between the ARTag 215 and the picking tool 320. The camera system 125 utilizes the calibration correction factor to update information about the position of one or more devices, such as the position of the robotic arm 140, picking tool 320, tote 325, and/or item 330 as examples.

After calculating the calibration correction factor, the camera system 125 proceeds to stage 1420. At stage 1420, the camera system 125 automatically calibrates a device in the facility 115. In one embodiment, the camera system 125 calibrates the camera 205. For example, the camera system 125 may change the view and/or settings of the camera 205 based on the calibration correction factor. The camera system 125 is further configured to calibrate the robotic arm 140, picking tool 320, and/or the tote 325 at stage 1420. In one example, the camera system 125 may adjust a calculation about the movement of the robotic arm 140 and/or picking tool 320. In another example, the camera system 125 may send a command to adjust the physical position of the robotic arm 140, picking tool 320, and/or tote 325. In another embodiment, the camera system 125 calibrates picking and/or placing locations for the robotic arm 140 based on the calibration correction factor. For example, the camera system 125 may adjust a range for picking/placing locations, update information about unpickable locations in the item 330, and/or calibrate picking/placing locations in another way.

At stage 1425, the camera system 125 then determines a location for the robotic arm 140 to pick and/or place an item 330 within the tote 325. In one example, the camera system 125 may determine the location and orientation of an item 330 within a tote 325 and then determine a location and orientation for the picking tool 320 to pick the item 330. Similarly, the camera system 125 may determine a desired location and orientation to place the item 330 in another tote 325. Further, the camera system 125 determines one or more points on the item 330 for the picking tool 320 to pick the item 330. In another example, the camera system 125 may determine the locations of multiple items 330 and then determine an order for the robotic arm 140 to pick and/or place the items 330. In yet another example, the camera system 125 may determine a specific sequence of movements for the robotic arm 140 to perform in order to pick and/or place an item 330 based on the location and orientation of the item 330.

In one embodiment, the camera system 125 interfaces with the artificial intelligence system 305 at stage 1425. The camera system 125 is configured to utilize the artificial intelligence system 305 to plan picking/placing locations in the tote 325, plan picking points on the item 330, determine a path of movement for the robotic arm 140, and/or determine another aspect of a picking/placing operation. In one example, the artificial intelligence system 305 determines a path for the robotic arm 140 that avoids singularities. In another example, the artificial intelligence system 305 plans picking points on the item 330 based on the specific type of picking tool 320 on the robotic arm 140. As should be recognized, all or part of the method 1400 can be performed to calibrate and operate devices in the trailer loading facility 135 and/or another facility 115, such as with operations of the robotic mast vehicle 145, a shuttle robot, gantry robot, and/or another robot. Further, the method 1400 can be used in conjunction with a variety of material handling processes, such as picking and placing items 330, rearranging items 330, and/or loading and unloading items 330 onto a tote 325, trailer 410, pallet, box, shelf, another container, and/or another structure.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Algorithm” generally refers to a sequence of instructions to solve a problem or to perform a task, such as a calculation. Typically, algorithms are implemented on computers. An algorithm on a computer may be used to automate a desired process or task on that computer or across multiple computers and/or other devices. As examples, a computer may utilize an algorithm to make a prediction based on data, control a robotic device to move along a desired path, and/or calculate the solution to an equation. A human may determine the instructions of an algorithm and program the algorithm onto a computer or other device. In some cases, a computer or other machine may determine at least part of an algorithm. For example, an artificial intelligence system may determine an algorithm for performing a desired task. Additionally, algorithms, such as machine learning algorithms, may be utilized to teach an artificial intelligence system to create new algorithms or improve existing algorithms for performing desired tasks.

“Augmented Reality Tag” or “ARTag” generally refers to an object that is used as a point of reference for a camera or vision system. ARTags include a visual indicator, such as a design, image, pattern, and/or another visual marker as examples. In one specific example, a pattern on the ARTag can include multiple black and white squares. The visual indicator of an ARTag is detectable by a camera and/or a computer vision system. Typically, but not always, the camera and/or computer vision system utilizes the ARTag to determine the position of an object in view of the camera, determine the orientation of the object, determine the position of the camera, determine the orientation of the camera, and/or determine other information about an object and/or camera. In some cases, a computer vision system uses multiple ARTags. Further, some ARTags include an adhesive material, suction cup, fastener, and/or another coupling mechanism such as to mount to other objects or structures.

“Artificial intelligence” or “AI” generally refers to the ability of machines to perceive, synthesize, and/or infer information. AI may enable a machine to perform tasks which normally require human intelligence. For example, AI may be configured for speech recognition, visual perception, decision making, language interpretation, logical reasoning, and/or moving objects. Typically, AI is embodied as a model of one or more systems that are relevant to tasks that a machine is configured to perform. AI models may be implemented on a device, such as a mechanical machine, an electrical circuit, and/or a computer. AI models may be implemented in an analog or digital form and may be implemented on hardware or software. The implementation of AI may also utilize multiple devices which may be connected in a network.

“Bin” or “Tote” generally refers to a container or structure that can store or support physical objects. In one embodiment, a bin refers to a container, surface, or structure that is used in a picking system. For example, a bin may be a basket, box, crate, pallet, vehicle, conveyor, shelving structure, storage device, table, and/or a stationary surface. A bin may define an opening or have one or more unclosed sides to allow items to be added to or removed from the bin.

“Camera” generally refers to a device that records visual images. Typically, a camera may record two- and/or three-dimensional images. In some examples, images are recorded in the form of film, photographs, image signals, and/or video signals. A camera may include one or more lenses or other devices that focus light onto a light-sensitive surface, for example a digital light sensor or photographic film. The light-sensitive surface may react to and be capable of capturing visible light or other types of light, such as infrared (IR) and/or ultraviolet (UV) light.

“Computer” generally refers to any computing device configured to compute a result from any number of input values or variables. A computer may include a processor for performing calculations to process input or output. A computer may include a memory for storing values to be processed by the processor, or for storing the results of previous processing. A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network interface to perform various network communications upon request. A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. A computer may include one or more physical processors or other computing devices or circuitry and may also include any suitable type of memory. A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer. The concept of “computer” and “processor” within a computer or computing device also encompasses any such processor or computing device serving to make calculations or comparisons as part of a disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

“Computer Vision” generally refers to the ability of a computer to obtain information from images and/or videos. Computer vision may perform similar tasks as in a human visual system, for example recognizing objects, tracking motion of objects, determining three-dimensional poses, determining three-dimensional shapes, and/or detecting visual events. A computer or other device may use computer vision to analyze image and/or video data recorded by a camera and/or vision system. In some embodiments, computer vision utilizes artificial intelligence to perform tasks. For example, computer vision may involve one or more artificial neural networks that are trained to obtain certain information from given images and/or videos.

“Convolutional Neural Network” or “CNN” generally refers to an artificial neural network wherein one or more neurons in at least one layer of the artificial neural network perform a mathematical convolution on an input to that layer. As examples, CNNs are used for identifying objects in an image, tracking an object in a video, classifying images, identifying words in speech, understanding meaning from text, generating text, generating images, and/or performing other tasks. In some cases, a CNN more accurately generates, analyzes, and/or performs other tasks related to images and video than other types of neural networks. In one example, the neurons of each layer in a CNN are fully connected such that each neuron of one layer is connected to every neuron of neighboring layers. In some cases, the CNN includes features to mitigate negative effects of a fully connected neural network, such as overfitting data.

“Discriminative Network” or “Discriminator Network” or “Discriminator” generally refers to a neural network that evaluates outputs from another neural network in comparison to information from a training dataset. In one embodiment, the second neural network is a generator network. During evaluation, the discriminator may attempt to distinguish the output of the generator network from information obtained from the training dataset. The discriminator may also send information to the generator network based on the evaluation of the output of the generator network.

“End of Arm Tool” (EoAT) or “End Effector” generally refers to a device at the end of the robotic arm that is designed to interact with the environment. The nature of this interaction of the device with the environment depends on the application of the robotic arm. The EoAT can for instance interact with an SKU or other environmental objects in a number of ways. For example, the EoAT can include one or more grippers, such as impactive, ingressive, astrictive, and/or contiguitive type grippers. Grippers typically, but not always, use some type of mechanical force to grip objects. However, other types of interactions, such as those based on suction or magnetic force, can be used to secure the object to the EoAT. By way of non-limiting examples, the EoAT can alternatively or additionally include vacuum cups, electromagnets, Bernoulli grippers, electrostatic grippers, van der Waals grippers, capillary grippers, cryogenic grippers, ultrasonic grippers, and laser grippers, to name just a few.

“Generative Network” or “Generator” generally refers to a neural network that generates candidates as outputs. As examples, the output candidates are images, videos, speech, text, and/or instructions for a machine. The generator is configured to produce outputs that are similar to or indistinguishable from information obtained from a training dataset. In some cases, the outputs of a generator are evaluated by another neural network, for example a discriminator network. In one embodiment, the generator is given random data as input. The generator may perform operations on the input data. In some cases, the generator also receives information from a discriminator network that is used to train the generator and modify the operations of the generator.

“Image property” generally refers to a characteristic of an image that affects the quality in some way. For example, image properties include brightness, contrast, vibrance, hue, saturation, color, exposure, gamma values, offset, sharpness, blur, and/or other characteristics of an image. In some cases, image properties can be affected by changing settings on a camera, such as widening the aperture to increase brightness as an example. In some cases, post-processing an image can cause changes to image properties, such as using a computer to change the brightness, contrast, and/or another property of an image. Further, environmental factors can cause changes in image properties, such as lighting affecting the brightness and/or vibrations affecting the blur of an image as examples. Typically, but not always, image properties do not refer to the objects captured in the image. In some cases, however, physical properties of the objects can affect certain image properties. For example, the amount of emitted or reflected light from an object can cause changes in the brightness and/or sharpness of an image.

“Input/Output (I/O) Device” generally refers to any device or collection of devices coupled to a computing device that is configured to receive input and deliver the input to a processor, memory, or other part of the computing device and/or is controlled by the computing device to produce an output. The I/O device can include physically separate input and output devices, or the input and output devices can be combined together to form a single physical unit. Such input devices of the I/O device can include keyboards, mice, trackballs, and touch sensitive pointing devices such as touchpads or touchscreens. Input devices also include any sensor or sensor array for detecting environmental conditions such as temperature, light, noise, vibration, humidity, and the like. Examples of output devices for the I/O device include, but are not limited to, screens or monitors displaying graphical output, a projecting device projecting a two-dimensional or three-dimensional image, or any kind of printer, plotter, or similar device producing either two-dimensional or three-dimensional representations of the output fixed in any tangible medium (e.g., a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Item” generally refers to an individual article, object, or thing. Commonly, but not always, items are handled in warehouse and material handling environments. The item can come in any form and can be packaged or unpackaged. For instance, items can be packaged in cases, cartons, bags, drums, containers, bottles, cans, pallets, and/or sacks, to name just a few examples. The item is not limited to a particular state of matter such that the item can normally have a solid, liquid, and/or gaseous form for example.

“Machine Learning” or “Machine Learning Algorithm” generally refers to a way of developing methods for performing tasks within artificial intelligence (AI) systems. Machine learning algorithms build models based on given sets of sample data. Using these models, a machine learning algorithm may make predictions or decisions about performing tasks and may improve the ability of an AI system to perform those tasks. Examples of machine learning include supervised learning, unsupervised learning, reinforcement learning, deep learning, and statistical learning. Machine learning algorithms can be implemented on a device, for example a computer or network of computers. Implementations of machine learning may also incorporate various types of models, including artificial neural networks, decision trees, regression analysis, Bayesian networks, gaussian processes, and/or genetic algorithms.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random-Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including Static Random Access Memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as Non-Volatile Read Access memory (NVRAM), flash memory, non-volatile Static RAM (nvSRAM), Ferroelectric RAM (FeRAM), Magnetoresistive RAM (MRAM), Phase-change RAM (PRAM), Conductive-Bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Model” generally refers to a representation of a system, process, and/or object. Models modify one or more inputs using equations and/or logical operations to produce one or more outputs. A variety of systems, processes, and objects can be represented by models, including networks of neurons in a brain. Some models do not exactly portray the system or process and are a generalized or estimated representation to a certain extent. Some models produce varying outputs in response to the same input. For example, a statistical model of a system may involve probabilistic distributions based on randomly generated numbers such that the output is random to a certain degree.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices. Computers coupled to a network may be referred to as “nodes” or as “hosts” and may originate, broadcast, route, or accept data from the network. Nodes can include any computing device such as personal computers, phones, and servers as well as specialized computers that operate to maintain the flow of data across the network, referred to as “network devices”. Two nodes can be considered “networked together” when one device is able to exchange information with another device, whether or not they have a direct connection to each other. Examples of wired network connections may include Digital Subscriber Lines (DSL), coaxial cable lines, or optical fiber lines. The wireless connections may include BLUETOOTH®, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g. 802.11(a), 802.11(b), 802.11(g), or 802.11(n) to name a few). Wireless links may also include or use any cellular network standards used to communicate among mobile devices including 1G, 2G, 3G, 4G, or 5G. The network standards may qualify as 1G, 2G, etc. by fulfilling a specification or standards such as the specifications maintained by the International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced. Cellular network standards may use various channel access methods such as FDMA, TDMA, CDMA, or SDMA. Different types of data may be transmitted via different links and standards, or the same types of data may be transmitted via different links and standards. The geographical scope of the network may vary widely. Examples include a Body Area Network (BAN), a Personal Area Network (PAN), a Local-Area Network (LAN), a Metropolitan Area Network (MAN), a Wide Area Network (WAN), or the Internet. A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks. A network may utilize different communication protocols or messaging techniques including layers or stacks of protocols. Examples include the Ethernet protocol, the Internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP Internet Protocol suite may include the application layer, transport layer, Internet layer (including, e.g., IPv6), or link layer.

“Neural Network” or “Artificial Neural Network” generally refers to a model composed of multiple nodes. Each node receives a signal from one or more inputs or other nodes. Each node may also perform an operation on the received signal. Each node then sends a signal to one or more other nodes or outputs. The nodes may be arranged in layers such that one or more signals travels across the layers sequentially. The neural network may be given data that trains the neural network. The neural network may be trained to perform a variety of tasks, for example to recognize objects in an image, recognize patterns in a sequence, replicate motion, and/or approximate a function.

“Pickable” generally refers to the quality of an object or a bin that contains the object to be picked by a robotic arm or other equipment. An object may be determined to be pickable if a manipulator or end of arm tool on a robotic arm or other equipment is capable of picking that object. For example, a claw on the end of a robotic arm is capable of grasping a certain pickable object. Conversely, various factors may cause an object to not be pickable, even if the equipment is typically capable of picking that object. In some examples, the object is oriented in an undesirable position or a path to the object is blocked by other objects or part of a container, and the object is determined to be unpickable. An object may be determined to be pickable through various means, for example through a computer vision system that captures and analyzes visual data about the object and/or through physical picking attempts by a robotic arm or other equipment.

“Picking” generally refers to grasping and/or retrieving one or more items from a receptacle. The receptacle may be a container or surface that supports or encloses items. For example, items can be picked from a basket, box, crate, pallet, vehicle, conveyor, shelving structure, storage device, or a stationary surface. Picking may be used to grasp or retrieve items in a variety of applications. For example, picking may be utilized for fulfillment of orders, storage, packaging, unpackaging, inventory management, manufacturing, or assembling. The geometry, rigidity, and other properties of the Items can vary, and a system may be configured to pick one or more types of items. Typically, picking may be performed automatically by a robotic arm or other robotic equipment.

“Placing” generally refers to releasing and/or setting down one or more items into a receptacle. The receptacle may be a container or surface that supports or encloses items. For example, items can be picked from a basket, box, crate, pallet, vehicle, conveyor, shelving structure, storage device, or a stationary surface. Typically, placing is performed automatically by a robotic arm or other robotic equipment. In some examples, placing is performed by a robot after a picking operation. For example, a robot may place an item into a bin after picking that item from a conveyor belt. Placing may be used to release or set items in a variety of applications. For example, placing may be utilized for fulfillment of orders, storage, packaging, unpackaging, inventory management, manufacturing, or assembling. The geometry, rigidity, and other properties of the Items can vary, and a system may be configured to place one or more types of items.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of 2200 Mission College Boulevard, Santa Clara, Calif. 95052, USA. In another example, the processor uses a Reduced Instruction Set Computing (RISC) architecture, such as an Advanced RISC Machine (ARM) type processor developed and licensed by ARM Holdings of Cambridge, United Kingdom. In still yet other examples, the processor can include a Central Processing Unit (CPU) and/or an Accelerated Processing Unit (APU), such as those using a K8, K10, Bulldozer, Bobcat, Jaguar, and Zen series architectures, supplied by Advanced Micro Devices, Inc. (AMD) of Santa Clara, California. Another example of a processor is an Application-Specific Integrated Circuit (ASIC). An ASIC is an Integrated Circuit (IC) customized to perform a specific series of logical operations for controlling the computer to perform specific tasks or functions. An ASIC is an example of a processor for a special purpose computer, rather than a processor configured for general-purpose use. An application-specific integrated circuit generally is not reprogrammable to perform other functions and may be programmed once it is manufactured. In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. An FPGA may be programmed to perform a specific series of instructions which may be retained in nonvolatile memory cells in the FPGA. The FPGA may be configured by a customer or a designer using a Hardware Description Language (HDL). An FPGA may be reprogrammed using another computer to reconfigure the FPGA to implement a new set of commands or operating instructions. Such an operation may be executed in any suitable means such as by a firmware upgrade to the processor circuitry. Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, and the unknown number may automatically change over time as well. The concept of a “processor” includes a device configured or programmed to make threshold comparisons, rules comparisons, calculations, or perform logical operations applying a rule to data yielding a logical result (e.g., “true” or “false”). Processing activities may occur in multiple single processors on separate servers, on multiple processors in a single server with separate processors, or on multiple processors physically remote from one another in separate computing devices.

“Robot” generally refers to a machine, such as one programmable by a computer, capable of carrying out a complex series of actions automatically. Sometimes, but not always, the robot automatically performs complicated, often repetitive tasks. Occasionally, the robot resembles all or part of a living creature that is capable of moving independently and/or performing complex actions such as grasping and moving objects. A robot can be guided by an external control device, or the control may be embedded within the robot.

“Robotic Arm” or “Robot Arm” generally refers to a type of mechanical arm, usually programmable, with similar functions to a human arm. Links of the robot arm are connected by joints allowing either rotational motion (such as in an articulated robot) or translational (linear) displacement. The robot arm can have multiple axes of movement. By way of nonlimiting examples, the robot arm can be a 4, 5, 6, or 7 axis robot arm. Of course, the robot arm can have more or less axes of movement or freedom. Typically, but not always, the end of the robot arm includes a manipulator that is called an “End of Arm Tool” (EoAT) for holding, manipulating, or otherwise interacting with the cargo items or other objects. The EoAT can be configured in many forms besides what is shown and described herein.

“Semi-Supervised Learning” or “Semi-Supervised Machine Learning” generally refers to machine learning wherein an artificial intelligence (AI) model is trained using a combination of labeled and unlabeled data. In one example, a majority of the training data is unlabeled data. Semi-supervised learning may be utilized when there isn't a sufficient amount of labeled training data available to be used in machine learning. In some cases, a machine learning algorithm adds imprecise and/or generalized labels to the unlabeled data set before training an AI model. For example, in contrast to receiving a more reliably and/or accurately labeled data set, a machine learning algorithm receives unlabeled data and adds less accurate and/or reliable labels to the unlabeled data.

“Shuttle” generally refers to a mechanism or device that is able to transport one or more items that are resting on and/or in the device. Each shuttle is capable of moving independently of one another and is able to move in multiple directions (e.g., horizontally, vertically, diagonally, etc.) along a shuttle frame. In one example, the shuttle includes a power train that is configured to move the shuttle, a steering system to direct shuttle movement, a tote transfer mechanism with a lift mechanism, and a robotic arm configured to transfer items to and/or from the shuttle. The power train in one example includes wheels that are driven by an electric motor, but in other examples, the power train can be configured differently. For instance, the power train can include a hydraulic motor and/or a pneumatic motor.

“Singularity” generally refers to a configuration in which the movement of an end effector of a robot is blocked in a certain way. For example, the end effector may be forced to be temporarily stationary, may not be able to move in a certain direction, may be severely limited in movement, and/or may have movement affected in some other way. Singularities can occur in robots with multiple degrees of freedom, for example in a robotic arm or another type of robot. Typically, but not always, a singularity occurs when multiple joints on the robot are aligned in the same plane. Additionally, in some cases where a singularity occurs, controls for the robot determined on a computer are undefined and/or not feasible for the robot to perform.

“Supervised Learning” or “Supervised Machine Learning” generally refers to machine learning wherein an artificial intelligence (AI) model is trained using labeled data. Supervised learning trains the AI model by relating features within the training data to the data labels. A model that is trained using supervised learning is configured to output one or more labels that describe data from one or more inputs.

“Testing” generally refers to the process of assessing the performance of a model. In the context of machine learning, testing is performed on an artificial intelligence (AI) model. The models are assessed by evaluating their outputs when given a set of testing data as input. Typically, testing may occur after the process of validation and may be done on one model that is selected during validation. In some cases, testing is the final step in the development of an AI model.

“Testing Data” generally refers to data that is used in the process of testing models. Typically, testing data is used for testing artificial intelligence (AI) models. Testing data may be a subset of a larger data set that is used for other parts of developing AI models. For example, one initial data set may be divided into testing data and training data for developing an AI model. Testing data may include information that is used as input to a model and may include information about the expected output of a model. Information about the expected output may be used to evaluate the performance of a model during the testing process.

“Trailer” generally refers to an unpowered vehicle towed by another vehicle. For instance, a trailer can include a nonautomotive vehicle designed to be hauled by road, such as a vehicle configured to transport cargo, to serve as a temporary (or permanent) dwelling, and/or acting as a temporary place of business. Some non-limiting examples of trailers include open carts, semi-trailers, boat trailers, and mobile homes, to name a just few. Typically, trailers lack a power train for propelling themselves over long distances and require another powered vehicle to move them. However, trailers may include a power source, such as a battery or generator, for powering auxiliary equipment.

“Training” generally refers to the process of building a model based on given data. In the context of machine learning, training is used to teach artificial intelligence (AI) models information from a dataset and to make predictions. During training, models are given training data as input and output predictions for a target based on the given data. The models may be adjusted based on the outputs to improve the quality of predictions for the target. For example, a machine learning algorithm may adjust parameters of a model based on differences between the model output and information from the training data. The target of the model predictions may be included in information from the training data. Training may involve multiple iterations of models making predictions based on the data. In some cases, the training process is repeated or continued after a validation process.

“Training Data” generally refers to data that is used in the process of training models. Typically, training data is used for training artificial intelligence (AI) models. Training data may be a subset of a larger data set that is used for other parts of developing AI models. For example, one initial data set may be divided into testing data and training data for developing an AI model. Training data may include information that is used as input for a model and may include information about the expected output of a model. Training data may also include labels on data to better identify certain expected outputs. Models may be evaluated and adjusted based on labels or other information from the training data during the training process.

“Unsupervised Learning” or “Unsupervised Machine Learning” generally refers to machine learning wherein an artificial intelligence (AI) model is developed based on unlabeled data. In unsupervised learning, the AI model learns from the input data by observing patterns and characterizes the data based on probability densities, combinations of input features, and/or other aspects of the patterns in the data. In some cases, the AI model is trained to mimic the input data, and an error is evaluated between the output of the model and the input data. Unsupervised learning is typically used to generate content. As examples, unsupervised learning is used to train an AI model to generate images, generate audio, write text, determine an action, and/or produce other outputs. Conversely, unsupervised learning is used to obtain information from data in some cases. As examples, unsupervised learning is used to train an AI model to cluster images into groups, cluster text passages into groups, identify anomalies in data, and/or recognize other characteristics of the data.

“Validation” generally refers to the process of evaluating the performance of a model after training. In the context of machine learning, validation is performed on an artificial intelligence (AI) model. The models are given a set of validation data and the outputs of models are evaluated. Validation may be used to select the most accurate models from multiple trained models. Validation may also be used to determine if additional training is needed to improve a model. In cases where additional training is used after the initial validation, additional validation may be used after that training. In some cases, validation is followed by a final testing process.

“Validation Data” generally refers to data that is used in the process of validation for models. Typically, validation data is used for validation of artificial intelligence (AI) models. Validation data may be a subset of a larger data set that is used for other parts of developing AI models. For example, one initial data set may be divided into validation data and training data for developing an AI model. Validation data may include information that is used as input for a model and may include information about the expected output of a model. Models may be evaluated based on information from the validation data during the validation process.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Vision System” generally refers to one or more devices that collect data and form one or more images by a computer and/or other electronics to determine an appropriate position and/or to “see” an object. The vision system typically, but not always, includes an imaging-system that incorporates hardware and software to generally emulate functions of an eye, such as for automatic inspection and robotic guidance. In some cases, the vision system can employ one or more video cameras, Analog-to-Digital Conversion (ADC), and Digital Signal Processing (DSP) systems. By way of a non-limiting example, the vision system can include a charge-coupled device for inputting one or more images that are passed onto a processor for image processing. A vision system is generally not limited to just the visible spectrum. Some vision systems image the environment at infrared (IR), visible, ultraviolet (UV), and/or X-ray wavelengths. In some cases, vision systems can interpret three-dimensional surfaces, such as through binocular cameras.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 material handling system
105 computer system
110 wide area network
115 facility
120 robot
125 camera system
130 picking facility
135 trailer loading facility
140 robotic arm
145 robotic mast vehicle
205 camera
210 computer
215 ARTag
305 artificial intelligence system
310 network
320 picking tool
325 tote
330 item
405 trailer loading tool
410 trailer
500 computer
505 processor
510 memory
515 I/O device
520 network interface
600 first tote image
700 second tote image
800 third tote image
900 first trailer image
1000 second trailer image
1100 third trailer image
1200 method
1205 stage
1210 stage
1215 stage
1220 stage
1300 method
1305 stage
1310 stage
1315 stage
1320 stage
1325 stage
1400 method
1405 stage
1410 stage
1415 stage
1420 stage
1425 stage

What is claimed is:

1. A system, comprising:
a camera configured to capture two or more images of one or more objects that are stationary;
an artificial intelligence (AI) system operatively coupled to the camera;
wherein the images of the objects form an image training set that is used by the artificial intelligence (AI) system to develop a machine learning model for the objects;
wherein the image training set has one or more modified images with at least one image property different from the other images; and
a robot configured to handle one or more items based on the machine learning model developed by the artificial intelligence (AI) system.

2. The system of claim 1, wherein the image training set includes at most 2,500 images.

3. The system of claim 1, wherein the modified images form 30% to 70% of the images in the training set.

4. The system of claim 1, wherein the camera is configured to capture the images at regular intervals.

5. The system of claim 1, wherein the camera is configured to capture the images at irregular intervals.

6. The system of claim 1, wherein the camera is configured to create the modified images by changing the image property.

7. The system of claim 6, wherein the camera is configured to create the modified images by taking the images through a time lapse approach.

8. The system of claim 1, wherein the image training set includes at least 50 images.

9. The system of claim 8, wherein the image training set includes at most 2,500 images.

10. The system of claim 1, wherein the image training set has 100 to 2,500 images.

11. The system of claim 1, wherein the camera is configured to calculate a camera calibration correction factor.

12. The system of claim 1, wherein the camera is configured to pre-plan item pick points.

13. The system of claim 1, wherein the camera includes one or more programmable filter settings configured to modify a picking process.

14. The system of claim 1, wherein the camera is configured to interface with the AI system to limit movement of the robot to prevent singularities.

15. A method, comprising:
capturing with a camera two or more images of one or more objects;
creating an image training set from the images of the objects;
modifying at least one of the images in the image training set to create a modified image that has at least one image property different from the remaining images in the image training set;
developing with a machine learning system a machine learning model for the objects based at least on the image training set that contains modified image; and
performing an action with a robot based on the machine learning model.

16. The method of claim 15, wherein the machine learning system creates the modified image.

17. The method of claim 15, wherein the capturing includes capturing the images using a time lapse approach.

18. The method of claim 15, wherein the images in the image training set appear to be the same image to a human before the modifying.

19. The method of claim 15, wherein the modifying the images occurs during and after the capturing.

20. The method of claim 15, wherein the objects are stationary when the camera captures the images.
